(19) United States
(12) Patent Application Publication
(10) Pub. No.: US 2024/0209170 A1
(43) Pub. Date: Jun. 27, 2024

(54) FOAMED SEALING ELEMENT AND CONTAINER CLOSURE COMPRISING THE FOAMED SEALING ELEMENT

(71) Applicant: SILGAN HOLDINGS INC., Stamford, CT (US)

(72) Inventors: Juergen KINTSCHER, Wedemark (DE); Andreas MANIERA, Neustadt (DE)

(21) Appl. No.: 17/756,354

(22) PCT Filed: Nov. 18, 2020
(86) PCT No.: PCT/IB2020/060857

§ 371 Date: Jun. 2, 2023

(30) Foreign Application Priority Data
Nov. 29, 2019 (DE) 10 2019 132 561.7

(51) Int. Cl. C08J 9/14

(52) U.S. Cl. CPC C08J 9/149; C08J 2201/03; C08J 2323/16; C08J 2323/22; C08J 2423/06

(57) ABSTRACT

A sealing element made of a polymer material comprises a polymer composition. The polymer composition comprises at least one polyolefin. The polymer material is in the form of a foamed material. The foamed polymer material has a density, determined according to DIN EN ISO 1183-1, of no more than 0.950 g cm³.

The invention relates to a polyolefin-based foamed sealing element which is inserted in a container closure.

Sealing elements based on polyolefins (thermoplastic elastomers) are relatively cost-intensive compared to PVC-based sealing elements.

In addition, polyolefin-based sealing elements are often relatively hard. In order to reduce the hardness, white oil is commonly added to the polymer compositions from which the sealing elements are formed. Specifically for fat-containing foods, white oil in a sealing element of a container closure considerably increases the total migration into the food.

One aim of the invention consists in providing a sealing element for a container closure, wherein the sealing element can be produced relatively cost effectively and has a relatively low hardness.

Moreover, the sealing element should have relatively low migration values.

Another aim of the invention consists in providing a sealing insert with a low oxygen permeability.

A use of the sealing element at low temperatures is also desirable.

The aim is achieved by a sealing element according to claim 1, which can be inserted into a container closure according to claim 51. The container closure closes a container according to claim 52. The aim is also achieved by the method for producing a foamed sealing element according to claim 53.

The sealing element comprises a polymer material or consists of a polymer material. The polymer material comprises a polymer composition. The polymer composition comprises at least one polyolefin. The polymer material is in the form of a foamed material. In particular, the foamed material has been produced by foaming the polymer composition. The foamed polymer material has a density of no more than 0.950 g cm⁻³.

The polymer material can comprise the polymer composition as matrix. In the matrix, pores which are filled with a gas move can be formed. The gas can comprise an inert gas, for example, carbon dioxide and/or nitrogen, each at a concentration above the concentration of the gases in air.

The pores of the polymer material in the matrix of the polymer composition can also be filled exclusively with carbon dioxide and/or nitrogen.

Compared to the density of the polymer composition (before foaming), the density of the of the polymer material (after foaming) is reduced by gas inclusions in formed pores.

Preferably, the density of the polymer material, determined according to DIN EN ISO 1183-1, is no more than 0.920 g cm⁻³. Particularly preferably, the polymer material has a density of no more than 0.875 g cm⁻³.

The density of the polymer material can be no more than 0.860 g cm⁻³. Specifically, the density of the polymer material is no more than 0.840 g cm⁻³. Preferably, the density of the foamed polymer material is no more than 0.820 g cm³. The density can also be no more than 0.800 g cm⁻³ or no more than 0.780 g cm⁻³.

The density of the polymer material can be at least 0.400 g cm⁻³, at least 0.500 g cm⁻³, at least 0.600 g cm⁻³ or at least 0.700 g cm⁻³.

The density of the polymer material can be between 0.400 g cm³ and 0.950 g cm⁻³, preferably between 0.400 g cm⁻³ and 0.920 g cm⁻³ or between 0.400 g cm⁻³ and 0.875 g cm⁻³.

The density of the polymer material can be between 0.400 g cm⁻³ and 0.860 g cm⁻³. Specifically, the density of the polymer material is between 0.400 g cm⁻³ and 0.840 g cm⁻³. Preferably, the density of the foamed polymer material is between 0.400 g cm⁻³ and 0.820 g cm⁻³. The density can also be between 0.400 g cm⁻³ and 0.800 g cm⁻³ or between 0.400 g cm⁻³ and 0.780 g cm⁻³.

Particularly preferably, the density of the polymer material is between 0.600 g cm⁻³ and 0.860 g cm⁻³.

The density of the polymer material can be determined according to DIN EN ISO 1183-1. The density is reduced by foaming. The density of the foamed polymer material can be reduced by at least 2%, 5% or 10% compared to the unfoamed polymer material.

The density of the unfoamed polymer material (substantially) corresponds to the density of the polymer composition if the polymer composition (exclusively) forms the matrix of the foamed polymer material.

The density of the foamed polymer material can also be reduced by at least 15%, preferably by at least 20%, more preferably by at least 25% compared to the density of the unfoamed polymer material (unfoamed state). Specifically, the density of the foamed polymer material is reduced by at least 30%, at least 35% or at least 50% compared to the density of the unfoamed material.

The density of the foamed polymer material is preferably reduced by no more than 75%, preferably no more than 65%, no more than 50% compared to the density of the unfoamed polymer material (unfoamed state)

The density of the foamed polymer material is preferably reduced by between 15% and 50% compared to the density of the unfoamed polymer material (unfoamed state).

The foaming can be carried out by physical or chemical means.

In the case of physical foaming, a gas, for example, an inert gas such as nitrogen or carbon dioxide, can be supplied to a softened (fluid) polymer composition, so that pores filled with the supplied gas form in the polymer composition.

In the case of chemical foaming, substances which chemically react under controlled conditions, wherein a gas (for example, carbon dioxide) is released, can be admixed with a polymer composition which can be in a softened or fluid state. The released gas forms pores in which the gas can collect.

Preferably, chemical foaming is used for the formation of the foamed polymer material.

Specifically, the polymer material is in the form of a closed-cell foamed material.

The polymer composition can comprise a butene copolymer with a melting temperature Tₘ between 30° C. and 130° C. The melting temperature Tₘ can be measured in the context of a DSC measurement by the second heating curve at a heating rate of 10° C./min.

Preferably, the melting temperature Tₘ of the butene copolymer is between 40° C. and 125° C. Particularly preferably, the melting temperature Tₘ of the butene copolymer is between 80° C. and 125° C. The melting temperature Tₘ of the butene copolymer can also be between 105° C. and 125° C.

The butene of the butene copolymer is preferably a 1-butene.

The comonomer of the butene copolymer can be propene, so that the butene copolymer is a butene-propene copolymer.

The butene copolymer can be a bipolymer, so that the butene copolymer in addition to butene has exactly one additional comonomer, for example, propene.

In the polymer composition, the butene copolymer proportion can be between 0.1% by weight and 80% by weight. The butene copolymer can also be present at between 5% by weight and 60% by weight in the polymer composition. Preferably, the proportion of the butene copolymer is between 8% by weight and 55% by weight in the polymer composition.

Weight percent indications in reference to the polymer composition in general relate to the proportion of the respective component relative to the total weight of all the components in the polymer composition. This including a propellant.

The polymer composition can comprise an additional butene copolymer. This additional butene copolymer is a different polymer type from the already described butene copolymer. The already described butene copolymer and the additional butene copolymer in the polymer composition can be distinguished by their physical properties (for example, density, melting temperature, hardness, etc.). The butene copolymers can also be distinguished by their structure (block copolymer, random copolymers, etc.). The butene copolymers can also be distinguished by the type of their comonomers (ethene, propene, etc.).

The butene in the additional butene copolymers can be a 1-butene. Ethene can be a comonomer of the additional butene copolymer.

The copolymerized butene proportion of the additional butene copolymer can be at least 60 mol %, in particular at least 80 mol %.

The additional butene copolymer can be a butene bipolymer, so that the butene bipolymer in addition to the butene has exactly one additional type of comonomer.

The additional butene copolymer can be represented in the polymer composition by a proportion between 10% by weight and 80% by weight. Preferably, the additional butene copolymer is present at a proportion between 22% by weight and 70% by weight in the polymer composition. Specifically, the polymer composition contains between 40% by weight and 65% by weight of the additional butene copolymer.

The polymer composition can comprise a polyethene.

The polyethene can be a homo-polyethene. Specifically, the homo-polyethene can be an LDPE (low density polyethylene) or an HDPE (high density polyethylene).

The polymer composition can comprise between 5% by weight and 60% by weight of the polyethene. Preferably, the proportion of the polyethene in the polymer composition is between 10% by weight and 45% by weight. Specifically, the polyethene is contained at between 15% by weight and 35% by weight in the polymer composition.

The polymer composition can comprise a random propene copolymer.

The random propene copolymer can have an ethene as comonomer. In particular, the random propene copolymer is a bipolymer.

Preferably, the polymer composition contains a random propene-ethene copolymer.

The random propene copolymer can be contained at between 5% by weight and 60% by weight in the polymer composition. Specifically, the proportion of the random propene copolymer is between 10% by weight and 45% by weight. Particularly preferably, the proportion of the random propene copolymer is between 15% by weight and 35% by weight in the polymer composition.

The polymer composition can also comprise a butene homopolymer which is specifically contained at between 5% by weight and 60% by weight in the polymer composition.

The butene of the butene homopolymer is specifically a 1-butene.

In particular, the butene homopolymer is present at between 10% by weight and 45% by weight in the polymer composition. Specifically, the proportion of the butene homopolymer in the polymer composition is between 15% by weight and 35% by weight.

The polymer composition can also comprise a copolymer wherein styrene is a comonomer of the copolymer.

In particular, the copolymer which comprises styrene as comonomer is an SBS, SEPS, SEEPS or SEBS. Particularly preferably, the copolymer which comprises styrene as comonomer is an SEBS.

The styrene-containing copolymer can be contained in the polymer composition at between 10% by weight and 70% by weight. Preferably, the proportion of the styrene-containing copolymer is between 20% by weight and 60% by weight in the polymer composition. The styrene-containing copolymer can also be contained at between 35% by weight and 55% by weight in the polymer composition.

The butene copolymer, in particular the butene-propene copolymer, can be present in the polymer composition at a proportion of at least 80% by weight. The butene copolymer can also be contained at at least 90% by weight in the polymer composition. In this case, the butene copolymer, in particular the butene-propene copolymer, can be the only polymer component of the polymer composition and the polymer composition in addition to the butene copolymer can only contain additives.

Due to the advantageous composition of the polymer composition, a high proportion of components which are liquid at 20° C. and 1000 hPa can be avoided. An example of such a component which is liquid at 20° C. and 1000 hPa is white oil. Therefore, the polymer composition preferably comprises no more than 10% by weight of a component which is liquid at 20° C. and 1000 hPa. Specifically, the polymer composition comprises no more than 5% by weight of such a component. In particular, the polymer composition does not comprise such a component (within the scope of the analytical possibilities on the date of application).

The polymer composition can be designed so that it has a static friction coefficient of no more than 0.50, preferably no more than 0.40. The friction coefficient is determined according to DIN EN ISO 8295. A low friction coefficient of the polymer composition allows an advantageous application possibility of the container closure, in particular during closing of a container with a container closure, wherein friction between the sealing element of the container closure and the container occurs, and during the opening of a container closed with a container closure.

The polymer composition can comprise between 43% by weight and 57% by weight of the butene copolymer and between 43% by weight and 57% by weight of the additional butene copolymer.

The polymer composition specifically comprises between 8% by weight and 16% by weight of the butene copolymer, between 55% by weight and 65% by weight of the additional butene copolymer, and between 18% by weight and 30% by weight of the homo-polyethene (in particular LDPE or HDPE).

Preferably, the polymer composition comprises between 8% by weight and 16% by weight of the butene copolymer, between 55% by weight and 65% by weight of the additional butene copolymer, and between 18% by weight and 30% by weight of the random propene copolymer.

Specifically, the polymer composition comprises between 8% by weight and 16% by weight of the butene copolymer, between 55% by weight and 65% by weight of the additional butene copolymer, and between 18% by weight and 30% by weight of the butene homopolymer.

The polymer composition can comprise between 8% by weight and 16% by weight of the butene copolymer, between 55% by weight and 65% by weight of the additional butene copolymer, between 3% by weight and 12% by weight of the homo-polyethene (in particular LDPE), and between 10% by weight and 22% by weight of the random propene copolymer.

Preferably, the polymer composition in general has an oxygen permeability rate of less than 3000 cm³ m⁻² d⁻¹ bar⁻¹, preferably less than 2500 cm³ m⁻² d⁻¹ bar⁻¹, more preferably less than 2000 cm³ m⁻² d⁻¹ bar⁻¹, more preferably less than 1500 cm³ m⁻² d⁻¹ bar⁻¹, more preferably less than 1200 cm³ m⁻² d⁻¹ bar⁻¹, more preferably less than 800 cm³ m⁻² d⁻¹ bar⁻¹, more preferably less than 500 cm³ m⁻² d⁻¹ bar⁻¹, particularly preferably less than 400 cm³ m⁻² d⁻¹ bar⁻¹.

In particular, the polymer composition has an oxygen permeability rate between 50 cm³ m⁻² d⁻¹ bar⁻¹ and 500 cm³ m⁻² d⁻¹ bar⁻¹.

The oxygen permeability rate can be determined according to DIN 53380. Due to a low oxygen permeability rate of the polymer composition, a reduced entry of oxygen into a container closed with one of the described container closures results. Thereby, a longer shelf life of a filling material in a filled and closed container can be ensured.

The total migration of the polymer composition can be no more than 1.2 mg cm⁻², preferably no more than 1.0 mg cm⁻², particularly preferably no more than 0.8 mg cm⁻², wherein the total migration of the polymer composition can be determined according to DIN-EN 1186-14.

If a filled container is closed by a container closure with a sealing element made of the polymer composition and in the case of a surface/mass ratio of 1 cm⁻² contact surface of the sealing element to 0.02 kg weight of the filling material in the container, a total migration limit value of 60 mg kg⁻¹ is complied with.

The polymer composition typically comprises additives. Preferably, the polymer composition comprises no more than 15% by weight additives. Specifically, the polymer composition comprises no more than 8% by weight additives. Particularly preferably, no more than 6% by weight are contained in the polymer composition.

Additives used can be selected from the group consisting of: pigments, nucleation agents, brighteners, stabilizers, surfactants, lubricants, antioxidants or combinations thereof.

The polymer composition can also comprise a heterophasic copolymer.

A heterophasic copolymer comprises (at least) two phases, wherein one of the phases is a continuous phase, and in it a second phase is dispersed. Preferably, the heterophasic copolymer is produced by a multistep reaction procedure, wherein the first phase is produced in one or more reactors and the second phase is produced in one or more other reactors.

Surprisingly, it has been found that the use of a heterophasic copolymer in a sealing element of a container closure enables the production of container closures with excellent properties. In the process, it has been shown that heterophasic copolymers with a first phase (continuous phase) of high crystallinity and with a second phase with elastomer properties dispersed therein are particularly suitable.

The proportion of the dispersed phase in the heterophasic copolymer typically is up to 30% by weight, specifically between 3% by weight and 27% by weight, even more specifically between 5% by weight and 20% by weight.

The proportion of the continuous phase in the heterophasic copolymer is preferably at least 70% by weight, more preferably between 73% by weight and 97% by weight, even more preferably between 80% by weight and 95% by weight.

The Shore D hardness of the heterophasic copolymer, measured according to DIN ISO 7619, can be no more than 65, in particular no more than 62. Thereby the hardness of the heterophasic copolymer is less than the hardness of homo-polypropene, wherein the hardness of homo-polypropene is typically more than Shore D 70.

Preferably, the heterophasic copolymer is a propene-ethene copolymer. In such a copolymer, the continuous phase can be formed as homo-polypropene and the elastomer phase dispersed therein can be a propene-ethene copolymer. Specifically, the heterophasic copolymer can be a propene-ethene bipolymer, wherein the propene-ethene bipolymer is formed exclusively from the monomers propene and ethene.

The polymer composition can comprise the heterophasic copolymer in a weight range between 0.1% by weight and 50% by weight (between 10% by weight and 50% by weight). Specifically, the polymer composition contains the heterophasic copolymer in a range between 0.1% by weight and 30% by weight (between 10% by weight and 30% by weight). Preferably, the proportion of the heterophasic copolymer in the polymer composition is between 0.1% by weight and 20% by weight. Particularly good results are achieved if the heterophasic copolymer is contained at between 5% by weight and 20% by weight in the polymer composition.

In addition to the heterophasic copolymer or, alternatively, in addition to the heterophasic copolymer, the polymer composition can contain a random propene-ethene copolymer, this in the same weight proportion as the heterophasic copolymer.

The polymer composition can also contain a butene copolymer. Specifically, the butene copolymer can be a butene bipolymer.

The butene of the butene copolymer is preferably a 1-butene.

In the butene copolymer, butene can be the predominant molar proportion of all the monomers. Specifically, the proportion of butene in the butene copolymer is at least 60 mol %. Preferably, the copolymerized proportion of butene in the butene copolymer is even greater, and namely at least 70 mol % or even at least 80 mol %.

Ethene can be a copolymer of the butene copolymer, so that the butene copolymer can be a butene-ethene copolymer. Specifically, the butene-ethene copolymer can be a butene-ethene bipolymer.

The butene copolymer can be contained at between 10% by weight and 85% by weight in the polymer composition. Preferably, the butene copolymer is contained at between 30% by weight and 85% by weight in the polymer composition. Very good results are achieved if the butene copolymer is contained at between 50% by weight and 75% by weight in the polymer composition.

The butene copolymer can be a random copolymer and can be present in (completely) amorphous form, it can thus not exhibit crystallinity.

Moreover, the polymer composition can contain a polyethene homopolymer. For this purpose, in particular LDPE (low density polyethylene) has been proven to be advantageous.

The polyethene homopolymer can be contained at between 0.1% by weight and 60% by weight in the polymer composition. The polyethene homopolymer can also be contained at between 0.1% by weight and 40% by weight in the polymer composition. Specifically, the polymer composition comprises between 0.1% by weight and 20% by weight of the polyethene homopolymer. Particularly preferably, the proportion of the polyethene homopolymer in the polymer composition is between 5% by weight and 20% by weight.

Preferably, the composition comprises between 10% by weight and 35% by weight (up to 35% by weight) of the heterophasic copolymer and between 65% by weight and 90% by weight (at least 65% by weight) of the butene copolymer.

The composition can also contain between 5% by weight and 30% by weight of the heterophasic copolymer, between 60% by weight and 85% by weight of the butene copolymer, and between 2% by weight and 20% by weight of the polyethene homopolymer.

Due to the advantageous composition of the polymer composition, it is possible to dispense with large proportions of homo-polypropene, so that the polymer composition can comprise no more than 20% by weight of homo-polypropene. In particular, the polymer composition comprises no more than 10% by weight of homo-polypropene. Most preferably, the polymer composition comprises no homo-polypropene within the scope of the analytic possibilities on the date of application. The homo-polypropene is to be understood to be a separate polymer and not a component of the heterophasic copolymer or of another polymer.

Due to the advantageous composition of the polymer compositions, a high proportion of components which are liquid at 20° C. and 1000 hPa can also be avoided. An example of such a component which is liquid at 20° C. and 1000 hPa is white oil. Therefore, the polymer composition preferably comprises no more than 10% by weight of a component which is liquid at 20° C. and 1000 hPa. Specifically, the polymer composition comprises no more than 5% by weight of such a component. In particular, the polymer composition does not comprise such a component (within the scope of the analytical possibilities on the date of application).

The polymer composition can be designed so that it has a static friction coefficient of no more than 0.50, preferably of no more than 0.40. The friction coefficient is determined according to DIN EN ISO 8295.

The polymer composition typically comprises additives. Preferably, the polymer composition comprises no more than 15% by weight additives. Specifically, the polymer composition comprises no more than 8% by weight additives. Particularly preferably, no more than 4% by weight are contained in the polymer composition.

Additives used can be selected from the group consisting of: pigments, nucleation agents, brighteners, stabilizers, surfactants, lubricants, antioxidants or combinations thereof.

Preferably, the polymer composition has an oxygen permeability rate of less than 3000 cm³ m⁻² d⁻¹ bar⁻¹, preferably less than 2500 cm³ m⁻² d⁻¹ bar⁻¹, more preferably less than 2000 cm³ m⁻² d⁻¹ bar⁻¹, more preferably less than 1500 cm³ m⁻² d⁻¹ bar⁻¹, more preferably less than 1200 cm³ m⁻² d⁻¹ bar⁻¹, more preferably less than 800 cm³ m⁻² d⁻¹ bar⁻¹, more preferably less than 500 cm³ m⁻² d⁻¹ bar⁻¹, particularly preferably less than 400 cm³ m⁻² d⁻¹ bar⁻¹.

The oxygen permeability rate can be determined according to DIN 53380. Due to a low oxygen permeability rate of the polymer composition, a reduced entry of oxygen into a container closed with one of the described container closures results. Thereby, a longer shelf life of a filling material in a filled and closed container can be ensured.

The total migration of the polymer composition can be no more than 1.0 mg cm⁻², preferably no more than 0.8 mg cm⁻², wherein the total migration of the polymer composition can be determined according to DIN-EN 1186-14.

The polymer composition can comprise a first polymer and a second polymer, wherein the first polymer is contained at between 5% by weight and 50% by weight (or between 5% by weight and 75% by weight) in the polymer composition and wherein the first polymer is a random copolymer with a Shore D hardness of at least 35 (measured according to DIN ISO 7619-1 at 23° C. and a holding time of 15 s). The second polymer is contained at between 50% by weight and 95% by weight (or between 25% by weight and 95% by weight) in the polymer composition. The second polymer is a polyolefin with a Shore A hardness of no more than 85 (measured according to DIN ISO 7619-1 at 23° C. and with a holding time of 15 s).

A comonomer of the first polymer can be propene, the first polymer can thus be a random propene copolymer.

The comonomer proportion of propene in the first polymer can be more than 50 mol %, preferably more than 60 mol %. Specifically, the comonomer proportion of propene in the first polymer can be at least 70 mol %, preferably at least 80 mol %.

1-Butene can be a comonomer of the first polymer. In the random 1-butene copolymer, the comonomer proportion of 1-butene can be more than 50 mol %, preferably more than 60 mol %. The comonomer proportion of 1-butene in the first polymer can be at least 75 mol %, preferably at least 90 mol %.

Ethene can also be a comonomer of the first polymer as random copolymer, so that the first polymer can be a random ethene copolymer. The proportion of the comonomer ethene in the first polymer can be less than 50 mol %, in particular the comonomer proportion of ethene is less than 40 mol % or even less than 30 mol %. Specifically, the proportion of ethene as comonomer in the copolymer is at most 20 mol %, in particular at most 10 mol %.

Likewise, 1-hexene or 1-octene can be a comonomer of the first polymer. The corresponding random 1-hexene copolymer or random 1-octene copolymer can contain 1-hexene or 1-octene as comonomer at a proportion of less than 50 mol %.

Ethene as comonomer of the first polymer can have a proportion of less than 50 mol %.

Specifically, the first polymer is a random propene-ethene copolymer, in particular with a comonomer proportion of propene of more than 50 mol % and a proportion of ethene of less than 50 mol %. Preferably, the random propene-ethene copolymer has a comonomer proportion of propene of at least 80 mol % and a comonomer proportion of ethene of no more than 20 mol %.

Preferably, the first polymer is a random propene-1-hexene copolymer or a random propene-1-octene copolymer, specifically with a propene molar proportion of more than 50 mol % and a proportion of 1-hexene or 1-octene of less than 50 mol %. In particular, the comonomer proportion of propene in the random copolymer is at least 70 mol % and the comonomer proportion of 1-hexene or 1-octene is at most 30 mol %.

It is also preferable that the first polymer is a random 1-butene-ethene copolymer, wherein the 1-butene proportion in the copolymer is particularly preferably more than 50 mol % and the proportion of ethene in the copolymer is less than 50 mol %. Specifically, the comonomer proportion of 1-butene in the random 1-butene copolymer is at least 90 mol % and the comonomer proportion of ethene in the copolymer is at most 10 mol %.

The first polymer can be a random propene copolymer wherein ethene, 1-hexene or 1-octene can be a comonomer of the first polymer.

The first polymer can also be a random ethene copolymer, wherein propene or 1-butene can be a comonomer of the first polymer.

The first polymer can be a bipolymer.

The density of the first polymer can be greater than 0.890 g cm⁻³. In particular, the density of the first polymer can be between 0.890 g cm⁻³ and 0.930 g cm⁻³. Specifically, the density of the first polymer is between 0.895 g cm³ and 0.920 g cm⁻³. In an embodiment, the density of the first polymer can be between 0.890 g cm⁻³ and 0.905 g cm⁻³. The density can be determined according to DIN EN ISO 1183-1.

The density of the second polymer can be less than 0.890 g cm⁻³. Specifically, the density of the second polymer is less than 0.880 g cm⁻³. In particular, the second polymer has a density between 0.890 g cm⁻³ and 0.860 g cm⁻³. The density of the second copolymer can also be between 0.880 g cm⁻³ and 0.865 g cm⁻³.

The MFI (mass flow index) of the second polymer can be less than 30 g/10 min, specifically less than 10 g/10 min, particularly preferably less than 5 g/10 min, wherein the MFI is determined according to DIN EN ISO 1133 at 190° C. and 2.16 kg. The MFI of the second polymer can be between 0.5 g/10 min and 50 g/10 min or between 0.5 g/10 min and 3 g/10 min.

The second polymer can have no melting temperature Tₘ, specifically no melting temperature Tₘ between 40° C. and 125° C. The melting temperature Tₘ can be determined by the second heating curve of a DSC measurement at a heating rate of 10° C. min⁻¹.

The MFI (DIN EN ISO 1133) of the first polymer, at a temperature of 190° C. and a weight of 2.16 kg, can be more 500 g/10 min, in particular more than 800 g/10 min, specifically more than 1000 g/10 min. The MFI of the first polymer can be between 1000 g/10 min and 1500 g/10 min or between 1000 g/10 min and 1400 g/10 min.

The MFI (DIN EN ISO 1133) of the first polymer, at a temperature of 230° C. and a weight of 5.0 kg, can be less than 50 g/10 min, in particular less than 30 g/10 min, specifically less than 10 g/10 min. The MFI of the first polymer can be between 4 g/10 min and 10 g/10 min.

In particular, the MFI of the first polymer, at a temperature of 230° C. and a weight of 5.0 kg, can be less than 75 g/10 min, specifically less than 50 g/10 min, more preferably less than 30 g/10 min. The MFI of the first polymer can be between 10 g/10 min and 30 g/10 min.

The first polymer can have a melting point Tₘ between 80° C. and 160° C. The melting temperature Tₘ can be determined by the second heating curve of a DSC measurement at a heating rate of 10° C./min. Specifically, the melting point Tₘ of the first polymer can be between 100° C. and 160° C.

The melting point Tₘ of the first polymer can be between 80° C. and 140° C., preferably between 90° C. and 110° C.

The melting point Tₘ of the first polymer can also be between 100° C. and 140° C., specifically between 110° C. and 140° C., particularly preferably between 125° C. and 140° C.

In an embodiment, the melting point Tₘ of the first polymer can be between 120° C. and 160° C., specifically between 140° C. and 160° C., particularly preferably between 145° C. and 160° C.

The first polymer can have a Shore D hardness (DIN ISO 7619-1, 23° C., 15 s) between 40 and 80. Preferably, the shore D hardness of the first polymer is between 50 and 70, specifically between 57 and 67.

The second polymer can be a copolymer, that is to say a polyolefin copolymer. Specifically, the second polymer is a random copolymer, that is to say a random polyolefin copolymer. 1-Butene can be a comonomer of the second polymer and/or ethene can be a comonomer of the second polymer.

Specifically, the second polymer is a 1-butene-ethene copolymer, particularly preferably a random 1-butene-ethene copolymer.

The comonomer proportion of 1-butene in the second polymer can be more than 50 mol %. Preferably, the comonomer proportion of 1-butene in the second polymer is at least 60 mol % or even at least 80 mol %.

The Shore A hardness (DIN ISO 7619-1, 23° C., 15 s) of the second polymer can be between 30 and 85. Preferably, the shore A hardness of the second polymer is between 40 and 80, particularly preferably between 50 and 70, specifically between 55 and 65.

In the polymer composition, the first polymer can be contained at between 10% by weight and 40% by weight. The first polymer can also be contained at between 15% by weight and 35% by weight, preferably between 20% by weight and 30% by weight, in the polymer composition.

In the polymer composition, in particular between 55% by weight and 85% by weight of the second polymer are contained. Preferably, the content of the second polymer in the polymer composition is between 60% by weight and 80% by weight, specifically between 65% by weight and 75% by weight.

It is preferable that the polymer composition contains no more than 10% by weight of components which are liquid at 20° C. and 1000 hPa. Specifically, the polymer composition contains no more than 5% by weight of such a component, and specifically the polymer composition is free of a component which is liquid at 20° C. and 1000 hPa, this within the scope of the analytical possibilities on the date of application or the date of priority.

In an embodiment, the polymer composition can be free of a copolymer which comprises styrene as comonomer.

The polymer composition can also be free of homo-polypropene.

In the polymer composition, up to 15% by weight of additives can be contained. In particular, in the polymer composition, up to 8% by weight of additives are contained, particularly preferably no more than 6% by weight of additives.

Additives in the polymer composition can be selected from the group consisting of: pigments, nucleation agents, brighteners, stabilizers, surfactants, lubricants, antioxidants and combinations thereof.

The polymer composition can have a static friction coefficient (determined according to DIN EN ISO 8295) of no more than 0.50, in particular a static friction coefficient of no more than 0.40. Specifically, the static friction coefficient of the polymer composition is between 0.30 and 0.40 or between 0.20 and 0.32.

The oxygen permeability rate of the polymer composition can be less than 3000 cm³ m⁻² d⁻¹ bar⁻¹, preferably less than 2500 cm³ m⁻² d⁻¹ bar⁻¹, more preferably less than 2000 cm³ m⁻² d⁻¹ bar⁻¹, more preferably less than 1500 cm³ m⁻² d⁻¹ bar⁻¹, more preferably less than 1200 cm³ m⁻² d⁻¹ bar⁻¹, more preferably less than 800 cm³ m⁻² d⁻¹ bar⁻¹, more preferably less than 600 cm³ m⁻² d⁻¹ bar⁻¹, preferably less than 500 cm³ m⁻² d⁻¹ bar⁻¹, more preferably less than 450 cm³ m⁻² d⁻¹ bar⁻¹, specifically no more than 400 cm³ m⁻² d⁻¹ bar⁻¹. Particularly preferably, the oxygen permeability rate of the polymer composition is between 300 cm³ m⁻² d⁻¹ bar⁻¹ and 400 cm³ m⁻² d⁻¹ bar⁻¹ or between 320 cm³ m⁻² d⁻¹ bar⁻¹ and 500 cm³ m⁻² d⁻¹ bar⁻¹.

The oxygen permeability rate can be measured according to DIN 53380. The rate of the oxygen permeability of the polymer composition in the container closure has an influence on the possible storage duration of a container filled with a food and closed with the container closure.

The total migration of the polymer composition can be no more than 1.20 mg cm⁻², preferably no more than 1.00 mg cm⁻², particularly preferably no more than 0.80 mg cm⁻², even more preferably no more than 0.75 mg cm⁻². The total migration of the polymer composition can be determined according to DIN-EN 1186-14. In particular, the total migration of the polymer composition can be between 0.50 mg cm⁻² and 0.80 mg cm²² or between 0.80 mg cm⁻² and 1.10 mg cm⁻².

Different polymers in the polymer composition can be distinguished by their physical properties (for example, density, melting temperature, hardness, etc.). Copolymers can also be distinguished by their structure (block copolymer, random copolymer, etc.). Copolymers can also be distinguished by the type of their comonomers (ethene, propene, etc.).

The polymer composition can comprise a polyalphaolefin and a second polyolefin. The polyalphaolefin (first polyolefin) has a kinematic viscosity of at least 4 cSt at a temperature of 100° C. The kinematic viscosity can be determined according to ASTM D 445 or ISO 3104, preferably according to ISO 3104. Additionally or alternatively, the polyalphaolefin has a dropping point of at most −10° C. The dropping point can be determined according to ASTM 5950. The second polyolefin is contained at a proportion of up to 95% by weight in the polymer composition.

At 23° C. and 1 bar, the polyalphaolefin of the sealing element of the container closure can be present in liquid form (liquid in the aggregate state).

The kinematic viscosity of the polyalphaolefin at a temperature of 100° C. can be between 4 cSt and 1500 cSt. Specifically, the kinematic viscosity of the polyalphaolefin at a temperature of 100° C. is between 50 cSt and 1000 cSt or between 120 cSt and 1000 cSt. Most preferably, the kinematic viscosity of the polyalphaolefin at a temperature of 100° C. is between 250 cSt and 1000 cSt. The kinematic viscosity of the polyalphaolefin at 100° C. can also be at least 250 cSt. The kinematic viscosity of the polyalphaolefin at a temperature of 100° C. can be at most 1500 cSt.

The kinematic viscosity of the polyalphaolefin at a temperature of 100° C. can also be between 2 cSt and 10 cSt, between 55 cSt and 75 cSt, between 140 cSt and 160 cSt, between 280 cSt and 320 cSt or between 900 cSt and 1100 cSt.

The dropping point (determined according to ASTM 5950) can be at most −20° C. Specifically, the dropping point of the polyalphaolefin is at most −30° C.

The density of the polyalphaolefin of the polymer composition can be up to 0.860 g cm⁻³. Specifically, the density of the polyalphaolefin is between 0.825 g cm⁻³ and 0.855 g cm⁻³. The density of the polyalphaolefin can also be between 0.840 g cm⁻³ and 0.855 g cm⁻³.

The weight average molecular weight Mw of the polyalphaolefin can be at least 440 Da. Specifically, the weight average molecular weight Mw of the polyalphaolefin is between 440 Da and 12,000 Da or between 1000 Da and 10,000 Da. Most preferably, the weight average molecular weight Mw of the polyalphaolefin is between 3000 Da and 10,000 Da.

The polyalphaolefin can be a metallocene polyalphaolefin. The polyalphaolefin can have been produced by using a metallocene catalyst.

The polyalphaolefin can be a Ziegler-Natta polyalphaolefin. The polyalphaolefin can have been prepared by using a Ziegler-Natta catalyst.

The polyalphaolefin can be a homopolymer or a copolymer.

Specifically, the polyalphaolefin is a homopolymer of a C₃ to C₂₂ alpha-olefin. For the production of the polyalphaolefin as homopolymer, alpha-olefins of length C₃ to C₂₂ are thus used as monomers. Preferably, for the polyalphaolefin as homopolymer, C₆ to C₁₄ alpha-olefins or C₈ to C₁₀ alpha-olefins are used as monomers.

The polyalphaolefin can be a 1-octene homopolymer (alpha-octene homopolymer) or a 1-decene homopolymer (alpha-decene homopolymer), preferably an alpha-decene homopolymer.

As copolymer, the polyalphaolefin is constructed from at least two different alpha-olefins of length C₃ to C₂₂ as comonomers. Specifically, two different alpha-olefins of length C₆ to C₁₄ or C₈ to C₁₀ are used as comonomers.

The polyalphaolefin can be a bipolymer.

The polyalphaolefin can be a synthetic fluid (at 23° C. and 1 bar); in particular, the polyalphaolefin is a completely synthetic fluid (at 23° C. and 1 bar).

The polyalphaolefin can be hydrogenated: in particular the polyalphaolefin is completely hydrogenated.

The polyalphaolefin can be a mixture of different polyalphaolefins. For example, the polyalphaolefin can be a mixture of at least two polyalphaolefins which are distinguished by their kinematic viscosity and/or their (co)monomers. For this purpose, at least two of the polyalphaolefins disclosed herein can be present in the form of a mixture.

The polyalphaolefin can be contained at a proportion of up to 65% by weight in the polymer composition. In general, the percent by weight indications relate to the total weight of the polymer composition. In particular, the proportion of the polyalphaolefin in the polymer composition is between 3% by weight and 65% by weight or between 3% by weight and 50% by weight. Even more specifically, the proportion of the polyalphaolefin in the polymer composition can be between 3% by weight and 30% by weight or between 5% by weight and 30% by weight.

The proportion of the polyalphaolefin in the polymer composition can be between 3% by weight and 7% by weight, between 7% by weight and 12% by weight, between 14% by weight and 20% by weight, between 17% by weight and 23% by weight, between 27% by weight and 33% by weight, or between 35% by weight and 45% by weight.

The second polyolefin in the polymer composition is different from the polyalphaolefin. For example, polymers of different type can be distinguished by their structure (for example, (co)monomers of the polymers) or by at least one property (for example, hardness, density).

The second polyolefin can have a Shore A hardness at 23° C. (DIN ISO 7619-1: holding time 15 s) of at most 90. In particular, the Shore A hardness at 23° C. is between 30 and 90.

The second polyolefin can be a plastomer or an elastomer.

Specifically, the second polyolefin is a polyolefin elastomer which has a density (DIN EN ISO 1183-1) between 0.860 g cm³ and 0.889 g cm⁻³.

The second polyolefin can also be a polyolefin plastomer wherein the density is between 0.890 g cm⁻³ and 0.910 g cm⁻³.

The second polyolefin can be an elastomer with a density of less than 0.860 g cm⁻³. In particular, the elastomer has a density between 0.780 g cm⁻³ and 0.859 g cm⁻³ or between 0.800 g cm³ and 0.859 g cm⁻³.

The second polyolefin can be a plastomer with a density of at most 0.910 g cm⁻³. In particular, the plastomer has a density between 0.860 g cm⁻³ and 0.910 g cm⁻³.

The second polyolefin can be a copolymer, in particular a random copolymer. Specifically, the second polyolefin is a copolymer which comprises 1-butene and a C₂, C₃ or C₅ to C₁₆ (alpha-)olefin as comonomers.

The proportion of the alpha-butene in the copolymer can be more than 50 mol %. Specifically, the proportion of the alpha-butene in the copolymer is at least 60 mol % or at least 80 mol %.

The second polyolefin can be a copolymer, in particular a random copolymer, made of propene and a C₂, C₄ or C₅ to C₁₆ (alpha-)olefin.

The proportion of propene in the copolymer can be more than 50 mol %. In particular, the proportion of propene in the copolymer can be more than 60 mol % or more than 70 mol %.

The second polyolefin can be a copolymer, in particular a random or block copolymer, which comprises ethene and a C₅ to C₁₆ (alpha-)olefin as comonomers. Specifically, a comonomer of the copolymer is ethene and an additional comonomer of the copolymer is a C₅, C₇, C₉ or C₁₀ to C₁₆ alpha-olefin.

The proportion of ethene in the copolymer can be more than 50 mol %. Specifically, the proportion of ethene in the copolymer is at least 60 mol % or at least 70 mol %.

In general, the second polyolefin is a bipolymer.

Particularly preferably, the second polyolefin is a 1-butene-ethene copolymer, wherein 1-butene is present at more than 50 mol % in the copolymer as bipolymer in particular.

Also preferably, the second polyolefin is a 1-butene-propene copolymer (bipolymer) with a molar proportion of 1-butene in the copolymer of more than 50 mol %.

The second polyolefin can have a proportion by weight of at most 80% by weight in the polymer composition. Specifically, the proportion of the second polyolefin the in polymer composition is at most 70% by weight.

In the polymer composition, the second polyolefin can also have a proportion between 5% by weight and 95% by weight. More specifically, the proportion of the second polyolefin in the polymer composition is between 20% by weight and 95% by weight or between 50% by weight and 95% by weight.

The second polyolefin can be present at a proportion between 55% by weight and 70% by weight in the polymer composition. The second polyolefin can also be present at between 83% by weight and 93% by weight in the polymer composition.

The polymer composition can comprise a third and/or a fourth polymer, wherein the third and the fourth polymer are of different type from the polyalphaolefin and the second polyolefin, and the third polymer is of different type from the fourth polymer. The polyalphaolefin, the second polyolefin, the third polymer and the fourth polymer are thus each polymers of different type.

The third and/or fourth polymer can be a polyolefin. The third and/or fourth polymer can have a Shore D hardness (DIN ISO 7619-1: holding time 15 s) at 23° C. of at most 60. Specifically, the Shore D hardness of the third and/or fourth polymer is between 20 and 60.

The third and/or fourth polymer can be a homopolymer. Specifically, the third and/or fourth polymer as homopolymer can be constructed from a C₂ to C₁₂ alpha-olefin. The third and/or fourth polymer as homopolymer can comprise a C₂ to C₈ alpha-olefin or a C₂ to C₆ alpha-olefin as monomer.

It is particularly preferable for the third and/or fourth polymer to be a polyethene homopolymer (for example, LDPE), a polypropene homopolymer or a 1-butene homopolymer.

The polypropene homopolymer can be a syndiotactic polypropene homopolymer. In particular, the degree of syndiotacticity (syndiotactic index) of the polypropene homopolymer can be at least 75%. The degree of syndiotacticity (syndiotactic index) can be determined according to the method described in U.S. Pat. No. 5,476,914 B by NMR, IR or GPC, preferably NMR.

The third and/or fourth polymer can be a copolymer.

Preferably, the third and/or fourth polymer is a polypropene copolymer. The polypropene copolymer can be a syndiotactic polypropene copolymer. The polypropene copolymer can have a propene proportion of at least 60 mol %, in particular at least 75 mol %, more preferably at least 90 mol %, even more preferably at least 95 mol %, most preferably at least 98 mol %.

The polypropene copolymer preferably comprises the monomers ethene and propene. Ethene can be represented at a proportion of no more than 2 mol % in the propene copolymer.

The degree of syndiotacticity of the polypropene copolymer can be at least 75%.

Each of the polymer compositions disclosed herein can comprise the syndiotactic polypropene homopolymer and/or the syndiotactic polypropene copolymer.

The third and/or fourth polymer as copolymer can have at least one or at least two (different) C₂ to C₁₂ alpha-olefins as comonomers. Specifically, the third and/or fourth polymer as copolymer can be constructed from at least one or at least two (different) C₂ to C₈ alpha-olefins or C₂ to C₆ alpha-olefins.

The third and/or fourth polymer can be a bipolymer.

Most preferably, the third and/or fourth polymer is a propene-ethene copolymer (bipolymer) wherein in particular the proportion of propene is greater than 50 mol %.

The third and/or fourth polymer as copolymer can be a propene-1-hexene copolymer (bipolymer) wherein the proportion of propene in the copolymer is more than 50 mol %.

The third and/or fourth polymer can each be contained at at most 35% by weight in the polymer composition. The third and/or fourth polymer can each be contained at between 5% by weight and 35% by weight or between 5% by weight and 27% by weight in the polymer composition. Specifically, the respective proportion of the third and/or fourth polymer is between 5% by weight and 18% by weight or between 11% by weight and 18% by weight.

The MFI (mass flow index) of the polymer composition can be less than 30 g/10 min, specifically less than 10 g/10 min, particularly preferably less than 5 g/10 min, wherein the MFI is determined according to DIN EN ISO 1133 at 190° C. and 2.16 kg.

The polymer composition can contain no more than 10% by weight of a mineral oil, for example, white oil; preferably, the polymer composition contains no more than 5% by weight of a mineral oil; particularly preferably, the polymer composition is free of a mineral oil.

In the polymer composition, up to 15% by weight of additives can be contained. In particular, in the polymer composition, up to 8% by weight of additives are contained, particularly preferably no more than 6% by weight of additives, most preferably no more than 5% by weight of additives.

Additives in the polymer composition can be selected from the group consisting of: pigments, nucleation agents, brighteners, stabilizers, surfactants, lubricants, antioxidants and combinations thereof.

The polymer composition can have a static friction coefficient (determined according to DIN EN ISO 8295) of no more than 0.50, in particular a static friction coefficient of no more than 0.40. Specifically, the static friction coefficient of the polymer composition is between 0.10 and 0.40 or between 0.15 and 0.40.

The oxygen permeability rate of the polymer composition can be at most 3000 cm³ m⁻² d⁻¹ bar⁻¹, preferably at most 2500 cm³ m⁻² d⁻¹ bar⁻¹, more preferably at most 2000 cm³ m⁻² d⁻¹ bar⁻¹, more preferably at most 1500 cm³ m⁻² d⁻¹ bar⁻¹, more preferably at most 1200 cm³ m⁻² d⁻¹ bar⁻¹, more preferably at most 800 cm³ m⁻² d⁻¹ bar⁻¹, more preferably at most 1300 cm³ m⁻² d⁻¹ bar⁻¹, more preferably at most 900 cm³ m⁻² d⁻¹ bar⁻¹, more preferably at most 750 cm³ m⁻² d⁻¹ bar⁻¹. Particularly preferably, the oxygen permeability rate of the polymer composition is between 300 cm³ m⁻² d⁻¹ bar⁻¹ and 1300 cm³ m⁻² d⁻¹ bar⁻¹ or between 300 cm³ m⁻² d⁻¹ bar⁻¹ and 900 cm³ m⁻² d⁻¹ bar⁻¹.

The oxygen permeability rate can be measured according to DIN 53380. The rate of the oxygen permeability of the polymer composition in the container closure has an influence on the possible storage duration of a container filled with a food and closed with the container closure.

The total migration of the polymer composition can be no more than 5.50 mg cm⁻², preferably no more than 3.50 mg cm⁻², particularly preferably no more than 2.50 mg cm⁻², even more preferably no more than 1.50 mg cm⁻². The total migration of the polymer composition can be determined according to DIN-EN 1186-14. In particular, the total migration of the polymer composition is between 0.50 mg cm⁻² and 3.00 mg cm⁻² or between 0.80 mg cm⁻² and 2.50 mg cm⁻².

Different polymers, that is to say polymers of different type, in the polymer composition can be distinguished by their physical properties (for example, density, melting temperature, hardness, etc.). Copolymers can also be distinguished by their structure (block copolymer, random copolymer, etc.). Copolymers can also be distinguished by the type of their comonomers (ethene, propene, etc.).

In general, each of the polymer compositions disclosed herein can be a polyolefin composition, so that the polymer composition exclusively comprises polyolefins as polymer components, wherein additives and optionally propellants as non-polyolefins can be contained in the polymer composition.

In general, each of the polymer compositions can be free of PVC (polyvinyl chloride).

A sealing element can comprise a polymer material or consist of the polymer material. The polymer material comprises a polymer composition. The polymer composition contains polyvinyl chloride (PVC). The polymer material is in the form of a foamed material and the foamed polymer material has a density (DIN EN ISO 1183-1) of no more than 1.100 g cm⁻³.

The PVC can be soft PVC with a density between 1.200 g cm⁻³ and 1.350 g cm⁻³. The PVC can have a density between 1.150 g cm⁻³ and 1.350 g cm⁻³, in particular between 1.150 g cm⁻³ and 1.250 g cm⁻³.

The foamed polymer material can have a density (DIN EN ISO 1183-1) of no more than 1.000 g cm⁻³. In particular, the density of the foam polymer material is no more than 0.900 g cm⁻³, preferably no more than 0.850 g cm⁻³, preferably no more than 0.800 g cm⁻³, even more preferably no more than 0.780 g cm⁻³.

The polymer composition can comprise PVC, plasticizers and additives. Preferably, the polymer composition consists of PVC, plasticizers and additives.

The polymer composition preferably comprises between 20% by weight and 70% by weight, specifically between 30% by weight and 50% by weight, of plasticizers.

In general, it is preferable that each of the polymer compositions contains no oxygen scavenger.

In general, the (foamed) polymer material can consist of the polymer composition.

The foamed polymer material of the sealing element can be designed so that it has a static friction coefficient of no more than 0.80, preferably no more than 0.70, more preferably no more than 0.60, even more preferably no more than 0.50, most preferably no more than 0.40. The friction coefficient is determined according to DIN EN ISO 8295.

The foamed polymer material can have an oxygen permeability rate of less than 3000 cm³ m⁻² d⁻¹ bar⁻¹, preferably less than 2800 cm³ m⁻² d⁻¹ bar⁻¹, more preferably less than 2600 cm³ m⁻² d⁻¹ bar⁻¹, more preferably less than 2400 cm³ m⁻² d⁻¹ bar⁻¹, more preferably less than 2200 cm³ m⁻² d⁻¹ bar⁻¹, more preferably less than 2000 cm³ m⁻² d⁻¹ bar⁻¹, more preferably less than 1600 cm³ m⁻² d⁻¹ bar⁻¹, particularly preferably less than 1400 cm³ m⁻² d⁻¹ bar⁻¹, more preferably less than 1200 cm³ m⁻² d⁻¹ bar⁻¹, even more preferably less than 1000 cm³ m⁻² d⁻¹ bar⁻¹, most preferably less than 800 cm³ m⁻² d⁻¹ bar⁻¹. The oxygen permeability rate of the foamed polymer material can be less than 600 cm³ m⁻² d⁻¹ bar⁻¹, preferably less than 500 cm³ m⁻² d⁻¹ bar⁻¹, more preferably less than 400 cm³ m⁻² d⁻¹ bar⁻¹. The oxygen permeability rate can be determined according to DIN 53380.

The total migration of the foamed material can be no more than 6.0 mg cm⁻², preferably no more than 5.0 mg cm⁻², particularly preferably no more than 4.0 mg cm⁻², more preferably no more than 3.0 mg cm⁻², even more preferably no more than 2.0 mg cm⁻², most preferably no more than 1.5 mg cm⁻², or no more than 1.2 mg cm⁻². The foamed polymer material can have a total migration of no more than 1.0 mg cm⁻², preferably no more than 0.8 mg cm⁻². The total migration of the polymer composition can be determined according to DIN-EN 1186-14.

Each of the sealing elements herein can be used in a container closure. A container closure can thus comprise each of the sealing elements disclosed herein.

The container closure typically comprises a support made of metal, plastic or metal and plastic (composite closure). The support of the container closure can be coated with an adhesive, in particular if the support is made of metal or comprises metal. The polymer composition can be applied on the support, and the sealing element can be formed thereon. Likewise, the sealing element can be formed outside of the support and subsequently inserted into the support, wherein the sealing element can be applied by other means for adhesion to the support (for example, via pressure and temperature).

The sealing element can be designed as disk-shaped or annular.

In the case of conventional container closures, for example, cam screw closures, the predominant portion of the sealing element is formed in the flat region of the support, so that an upper end of a container mouth comes in contact with the sealing element when the container closure closes a container. In particular, in the case of press-on twist-off container closures (PT container closures), a considerable proportion of the sealing element can also be formed in the skirt region of the support. In the case of composite PT container closures, for example, in the case of container closures marketed under the trade name Band-Guard, a plastic threading of the container closure can cooperate with a counter-threading of a container (for example, a glass container with outer threading).

During the closing of a container, a PT container closure is pressed onto the container mouth (press-on) while the sealing element in the heated state is sufficiently fluid. An outer threading in the mouth region of the container produces an inner threading (as negative of the outer threading) in the sealing element region on the skirt of the container closure support. The PT container closure is removed from the container by a twisting movement (twist-off).

The container closure can be a screw closure. Preferably, the container closure is a cam screw closure. The container closure can also be a press-on twist-off container closure or a composite closure.

The container closure can close a container. The container comprises a container mouth and a closable opening at the end of the container mouth. One of the disclosed container closures closes this opening.

The container can be a glass container, a plastic container or a metal container. In particular, the container is a glass container.

The container closure which closes the opening of the container can comprise a support and the sealing element. The sealing element can have a lower side and the container mouth can have an upper end. The sealing element of the container closure is typically wedged between the container mouth and the support of the container closure, so that the sealing element lies both against the upper end of the container mouth and against the lower side of the support. Specifically, the height of the sealing element between the upper end of the container mouth and the lower side of the support is no more than 1.0 mm. Preferably, this height is no more than 0.8 mm and particularly preferably no more than 0.7 mm. The height can be determined in axial direction of the container.

Analogously thereto, the height of the sealing element between the upper end of the container mouth and the lower side of the support can be at least 0.2 mm. Specifically, the height is at least 0.4 mm and particularly preferably at least 0.5 mm. The measurement of the height of the sealing element can occur in axial direction of the container.

Particularly preferably, the height of the sealing element between the upper end of the container mouth and the lower side of the support is between 0.3 mm and 0.9 mm.

For example, if the height of the sealing element before the application of the container closure on a container is 1.2 mm, the impression of the upper end of the container mouth into the sealing element (height between the upper end of the container mouth and the lower side of the support of no more than 1.0 mm) without the sealing element being cut through (height of the sealing element between the upper end of the container mouth and the lower side of the support of at least 0.2 mm) ensures a high degree of tightness of the container closed with the container closure.

Preferably, there is a vacuum in the closed container. The absolute pressure in the closed container can be no more than 200 hPa. Specifically, the absolute pressure in the closed container is no more than 100 hPa.

The container closed with the container closure can have a safety margin of no more than 10 mm, specifically the safety margin is no more than 8 mm. Preferably, the safety margin is no more than 6 mm. Most preferably, the safety margin is no more than 4 mm.

For the determination of the security measure, a container closed with a cam screw closure is stored at room temperature (23° C.) for a time period of 30 minutes. The relative position of the container closure with respect to the container is marked by applying a marking to the container closure skirt and the container wall, so that the circumferential distance between the marking on the container closure skirt and the container wall is zero. The markings are then on a straight line which is parallel to the longitudinal axis of the container. Subsequently, the container closure is completely removed from the container by unscrewing. Then, the container closure is applied onto the container and tightened until a slight resistance can be felt. The container closure is thus tightened until it is finger tight. Subsequently, the circumferential distance between the marking on the container closure skirt and the marking on the container wall is measured. The measured distance corresponds to the safety margin expressed in mm.

Due to the at least partially steep inclination of the thread pitches of containers and cam screw closures, the precision of the measurement of the safety measure is high, since the point at which a slight resistance during the tightening of the container closure can be felt (finger tight) can be precisely determined. Typically, the precision of the measurement of the safety measure on closed containers closed under the same conditions but by different persons is approximately ±1 mm.

By means of a suitable safety measure, it is ensured that the sealing element exerts an elastic force on at least the upper end of the container mouth when the container is closed with the container closure. This results in a high degree of tightness of the interior of the closed container.

A closed and filled container can be produced by providing a container with a container mouth and a closable opening at the end of the container mouth. The container is filled with a (solid and/or liquid) food through the opening of the container and the opening of the container is closed with a disclosed container closure.

The opening of the container can have a diameter of at least 20 mm. In particular, the diameter of the opening of the container is no more than 120 mm.

The container can be a glass container, a plastic container or a metal container.

Before the opening of the container is closed with the container closure, the container closure can be treated at a temperature of at least 90° C. Such a treatment can be carried out, for example, with water vapor.

In the container, a head space can be formed after the container has been filled with the food. After the filling, the head space in the container is the section of the container volume in which there is no food. Vapor can be supplied to the head space before the container closure is applied onto the container and thus the opening of the container is closed. In particular, the vapor can be water vapor.

The absolute pressure in the closed and filled container can be no more than 200 hPa. Specifically, the pressure in the closed and filled container can be no more than 100 hPa.

For the formation of an impression of the container mouth in the sealing element, the sealing element can be deformed at least 0.2 mm in axial direction of the container during the closing of the opening of the container with the container closure and/or during a thermal treatment of the closed and filled container. Preferably, this deformation of the sealing element is at least 0.4 mm. Specifically, the deformation is at least 0.5 mm.

Analogously thereto, the sealing element can be deformed no more than 1.0 mm for the formation of an impression of the container mouth in the sealing element during the closing of the opening of the container with the container closure and/or during a thermal treatment of the closed and filled container. In particular, the deformation is no more than 0.8 mm. Preferably, the deformation is no more than 0.7 mm. This in each case in axial direction of the container.

Particularly preferably, the deformation of the sealing element is between 0.3 mm and 0.9 mm.

The food can be poured aseptically into the container.

The food can also be poured at a temperature of no more than 10° C. into the container.

The food can also be poured at a temperature between 10° C. and 70° C. into the container.

Likewise, the food can be poured at a temperature between 70° C. and 98° C. into the container.

In the method, the closed and filled container can be thermally treated. Here, the temperature of the thermal treatment is above the temperature of the (solid and/or liquid) food during the filling of the container.

The thermal treatment can occur at a temperature of at least 60° C.

The thermal treatment can also occur at a temperature of no more than 135° C. (between 60° C. and 135° C.). In particular, the thermal treatment occurs at a temperature of up to 135° C. (between 60° C. and 135° C.) at an absolute ambient pressure of no more than 4.0 bar, preferably at an absolute ambient pressure between 1.0 bar and 4.0 bar.

Preferably, the pressure in the closed container during a thermal treatment is less than the pressure outside of the closed container.

In a method, a foamed sealing element can be produced. For this purpose, a propellant is introduced into a polymer composition. Each of the polymer compositions disclosed herein can be used. By means of the propellant, the polymer composition is foamed. Thereby, a foamed polymer material is obtained or produced. A sealing element is formed or shaped from the foamed polymer material.

Different components of the polymer composition can be mixed in an extruder or a kneader, in order to obtain the mixed polymer composition. The propellant can be added to the polymer composition.

For example, an extruder can comprise one or more feed lines for components of the polymer composition. The propellant can be introduced via one of the feed lines into the extruder, for example, as master batch. An at least partial reaction of the (active) components of the propellant can occur in the extruder. The reaction of the (active) components of the propellant can also occur completely in the extruder.

After the discharge of the polymer composition from the extruder with the (still not completely reacted) propellant, an additional reaction of the components of the propellant can occur. A foaming of the composition can occur outside of the extruder.

Immediately after the discharge, the discharged composition can be brought into the desired form of the sealing element.

A foamed polymer material is formed when no additional foaming of the polymer composition occurs.

A formation of the polymer composition (compounding), a foaming of the composition and/or a forming or shaping of a sealing element can also temporally overlap.

A sealing element can be formed by stamping or application onto a surface (for example, onto a surface of a container closure). Specifically, the sealing element can be formed by application of the polymer composition or of the polymer material onto a surface (container closure) and subsequent stamping or shaping.

The foaming of the polymer composition reduces the density thereof. The density of the foamed polymer material can be at least 2%, 5% or 10% lower than the density of the (unfoamed) polymer composition. The density of the foamed material is preferably at least 15%, more preferably at least 20%, even more preferably at least 25%, specifically at least 30%, most preferably at least 35% lower than the density of the (unfoamed) polymer composition.

For the foaming, up to 10% by weight of a propellant can be introduced into a polymer composition. Here, the proportion by weight is with respect to the total weight of the polymer composition with the propellant.

Preferably, between 0.1% by weight and 8.0% by weight of the propellant are introduced into the polymer composition. Specifically, between 0.1% by weight and 6.0% by weight or between 0.5% by weight and 5.0% by weight of the propellant are introduced into the polymer composition. Particularly preferably, between 0.2% by weight and 2% by weight of the propellant can be introduced into the polymer composition.

The propellant can comprise at least two different solids. Here, the two different solids can be distinguished by their chemical structure.

A first substance of the propellant can react with a second substance of the propellant (for example, the two different solids). During the reaction of the substances, a gas, for example, carbon dioxide, can form.

Due to the formation of the gas during the reaction of the substances in the propellant, the polymer composition can be foamed.

The first substance can be a carbonate or a carbamate. In particular, the first substance is an alkali, alkaline earth, aluminum, transition metal or ammonium carbonate or carbamate or a mixture thereof.

Specifically, the first substance is a sodium, magnesium, calcium, aluminum or iron carbonate or carbamate or mixtures thereof.

The first substance can comprise sodium carbonate, sodium hydrogen carbonate, magnesium carbonate, magnesium hydrogen carbonate, calcium carbonate, calcium hydrogen carbonate, aluminum carbonate, aluminum hydrogen carbonate, iron carbonate, iron hydrogen carbonate, ammonium carbonate, ammonium hydrogen carbonate or ammonium carbamate or a mixture thereof.

The second substance can comprise a salt. The salt can comprise phosphorus and/or sulfur. Specifically, the second substance contains a phosphate or a sulfate.

Particularly preferably, the second substance comprises acidic sodium pyrophosphate, monocalcium phosphate monohydrate, dicalcium phosphate dihydrate, sodium aluminum sulfate, sodium aluminum phosphate, calcium magnesium aluminum phosphate, calcium polyphosphate, magnesium polyphosphate or a mixture thereof. Specifically, the second substance comprises acidic sodium pyrophosphate.

It is particularly preferable that the second substance comprises at least two different compounds which each can react with the first substance and that a gas (carbon dioxide) is formed by the reaction. The first compound of the second substance can chemically react with the first substance, and the second compound of the second substance can chemically react with the first substance. A gas is formed by both reactions.

The quantity (molar quantity) of gas released by the reaction of the first compound of the second substance with the first substance within a unit of time (for example, 1 min or 5 min) can be greater than or less than the quantity (molar quantity) of gas released by the reaction of the second compound of the second substance with the first substance within the same unit of time. In other words, in the reactions of the first compound with the first substance and in the reaction of the second compound with the first substance, gas is formed at different rates or respectively the reactions occur at different rates.

Here, the quantities formed can differ by at least a factor of 1.2, preferably by at least a factor of 1.5.

The second substance can comprise acidic sodium pyrophosphate and sodium aluminum phosphate as first and second compound.

The first substance can comprise sodium hydrogen carbonate.

Preferably, no reaction occurs between the first substance and the second substance under ambient conditions (room temperature, 23° C.: 1 bar).

A reaction between the first substance and the second substance can be triggered by an elevated pressure and/or an elevated temperature.

In particular, a reaction between the first substance and the second substance can be triggered by a temperature of at least 70° C., specifically at a temperature of at least 100° C. Particularly preferably, the chemical reaction between the first substance and the second substance is triggered at a temperature between 120° C. and 200° C.

The propellant can comprise a separating agent. By means of the separating agent, a chemical reaction between the first substance and the second substance can be delayed or inhibited.

The sealing element can be inserted in a container closure. For this purpose, the polymer material or the polymer composition can be applied onto a container closure blank and formed by stamping. A sealing element can also be formed outside of a container closure blank from the polymer material or the polymer composition, and the sealing element can subsequently be introduced into the container closure blank and, in particular, made to adhere to the container closure blank by pressure and/or temperature.

Each of the sealing elements disclosed herein can be inserted into each of the container closures disclosed herein.

The embodiments of the invention are represented using an example and not in such a manner that limitations from the figures are applied to or read into the claims. Identical reference numerals in the figures indicate identical elements.

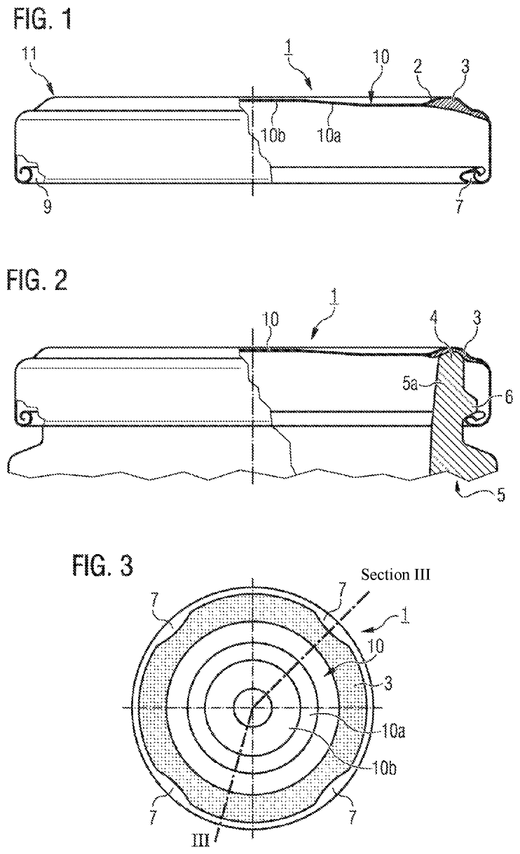

FIG. 1 shows a side view of a cam screw closure 1 with an annular sealing element 3, in partial section:

FIG. 2 shows a side view of the cam screw closure 1 with the sealing element 3 on a container 5, in partial section:

FIG. 3 shows the cam screw closure 1 with the sealing element 3 in a view from below:

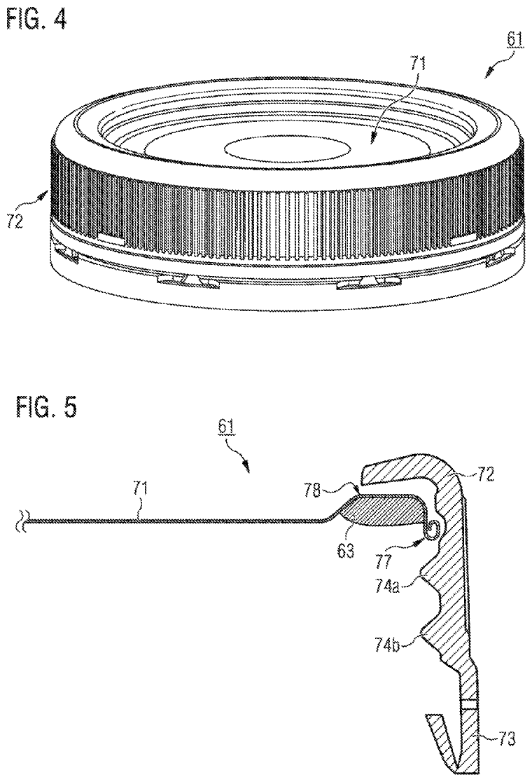

FIG. 4 shows an isometric view of a composite closure 61 (Combi-Twist);

FIG. 5 partially shows an axial section of the composite closure 61 (Combi-Twist) from FIG. 4:

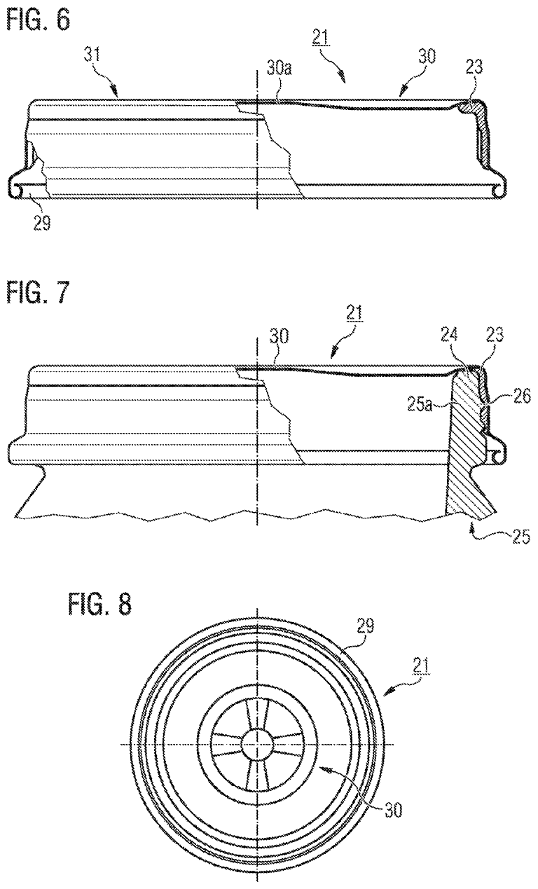

FIG. 6 shows a side view of a press-on twist-off closure 21 (PT closure) with a sealing element 23, in partial section:

FIG. 7 shows a side view of the PT closure 21 with the sealing element 23 on a container 25, in partial section:

FIG. 8 shows a top view of the PT closure 21:

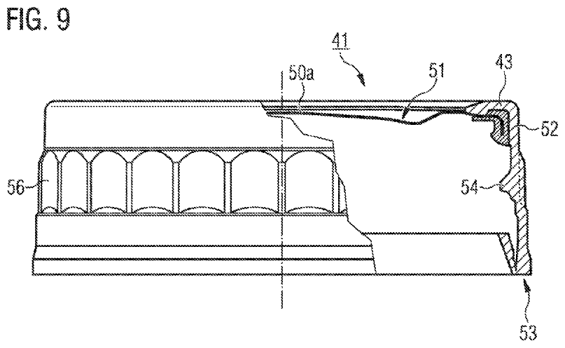

FIG. 9 shows a side view of a composite closure 41 (Band-Guard) with a sealing element 43, in partial section:

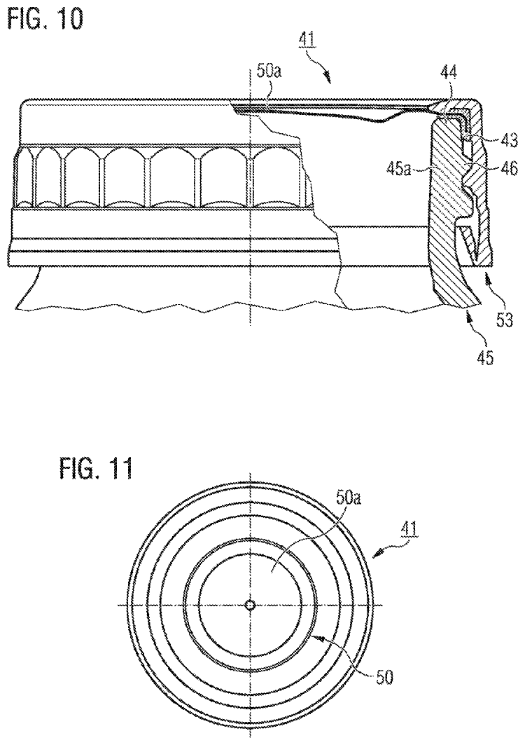

FIG. 10 shows a side view of the composite closure 41 (Band-Guard) with the sealing element 43 on a container 45, partially as cross section:

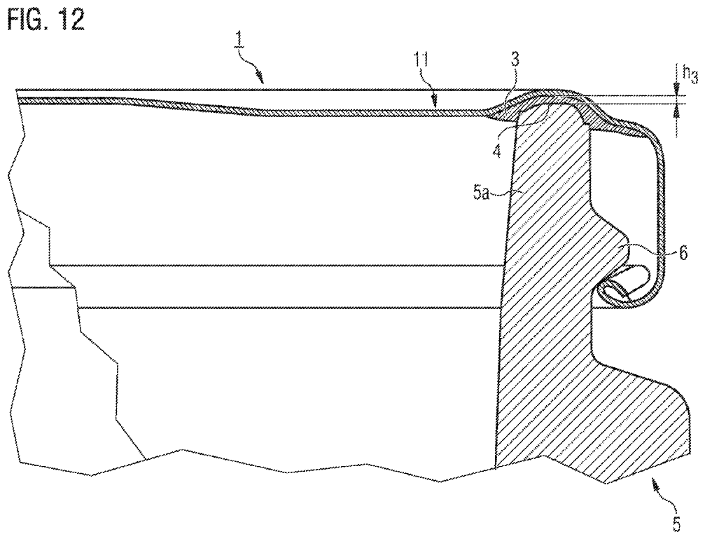

FIG. 11 shows a top view of the composite closure 41 (Band-Guard):

FIG. 12 shows an enlarged detail of the cam screw closure of FIG. 2.

FIGS. 1 and 3 show a cam screw closure 1. The cam screw closure 1 comprises a metallic support 11 and a sealing element 3. In the representation of FIG. 2, the cam screw closure 1 is applied onto a container 5. On the lower end of the cam screw closure 1, a rolling-in 9 is formed. Multiple cams 7 are formed, circumferentially distributed, out of the rolling-in 9. Cams 7 are formed by axial deformation of the rolling-in 9 and extend farther radially toward the center of the cam screw closure 1 than the rolling-in 9. The cam screw closure 1 represented in FIGS. 1 to 3 comprises four cams 7 which are formed evenly distributed circumferentially. The sections which are partially represented in FIGS. 1 and 2 correspond to section III-III in FIG. 3.

Close to the radially outer end section of the cam screw closure 1, a channel 2 is formed in the upper section 10 of the support 11. The sealing element 3 is arranged at least partially in the channel 2. In this embodiment, the sealing element 3 is designed as annular: in other embodiments, the sealing element 3 can be designed as disk-shaped or annular, this, in particular, if the diameter of the cam screw closure is small (for example, no more than 30 mm).

For the adhesive connection between the metallic support 11 and the sealing element 3, an adhesive is typically applied onto the side of the metallic support 11 which is in contact with the sealing element 3.

In FIG. 2, the cam screw closure 1 is applied onto a container 5. The container 5 comprises a container mouth 5a as upper section of the container 5. The container mouth comprises a threading 6 and an upper end 4 of the container mouth 5a. The threading 6 is formed circumferentially in the region of the container mouth 5a and extends circumferentially upward or downward (depending on the viewing angle).

For the application of the cam screw closure 1 onto a container 5, cams 7 are brought in contact with sections of the threading 6 and the cam screw closure 1 is rotated clockwise relative to the container 5. Due to the design of the threading 6 and the interaction of the cams 7 with the threading 6, the upper end 4 of the container mouth 5a moves in the direction of the sealing element 3 during the rotation of the cam screw closure 1 relative to the container 5. By further rotation of the cam screw closure 1, the upper end 4 of the container mouth 5a presses into the sealing element 3 and deforms it, so that a section of the upper end 4 of the container mouth 5a is covered by the sealing element 3, whereby the container 5 is sealingly closed. A sealing closure of the container 5 is particularly necessary in order to withstand an elevated pressure during a thermal treatment of the closed container 5 at temperatures above 70° C., 90° C. or even above 120° C.

The cam screw closure 1, as represented in FIGS. 1 to 3, comprises a safety button 10b which is formed in the upper section 10 of the support 11. Due to the inclination 10a in the upper section 10 of the support 11, the safety button 10b folds in the direction of the center of the container if a sufficiently large low pressure exists in the container. Such a vacuum can be generated by introducing water vapor into the container before the closing of the container with the closure.

If a consumer opens the container by removing the container closure, the pressure in the container rises to ambient pressure and the safety button 10b folds away from the center of the container. The folding back of the safety button 10b is accompanied by a characteristic sound, by means of which a consumer can recognize that a vacuum existed in the container before the opening of the container.

FIGS. 4 and 5 show a composite closure 61 (Combi-Twist) which can be applied, analogously to the described cam screw closure 1 can be applied by a rotation onto a container and which can be removed from the container by a rotation.

The composite closure 61 comprises a support with an upper metallic section 71 and a plastic section 72 which is formed as L-shaped. Close to the radial end of the metallic section 71 of the support, a channel 78 is formed and a rolling-in 77 is formed on the radial end of the metallic section 71. A sealing element is arranged at least partially in the channel 78.

Multiple threading elements 74a, 74b formed on the inner side of the plastic section 72 are in contact with a counter-threading in the region of the mouth of a container (not represented) onto which the composite closure 61 is to be applied. The plastic section 72 of the composite closure 61 moreover comprises a tamper-evident closure 73 which is designed similarly to the tamper-evident closure as in FIGS. 9 to 11 and which is described in greater detail in reference to FIGS. 9 to 11.

If the composite closure 61 is screwed onto a container by a rotation, the result is an analogous interaction of the container mouth of the container with the sealing element of the composite closure 61 as described in reference to the cam screw closure 1.

In FIGS. 6 to 8, a press-on twist-off closure 21 (PT closure) is represented. The PT closure 21 comprises a metallic support 31 with a rolling-in 29 on the lower end of the support 31 and a safety button 30a in the upper section 30 of the support 31.

A sealing element 23 is formed both in the region of the upper section 30 of the support 31 and over a considerable extent on the skirt of the support, which extends downward from the upper section 30 of the support 31. The PT closure 21, in contrast to the cam screw closure 1 and the composite closure 61, during the application onto a container 25, is pressed onto the container mouth 25a. During the pressing onto the container mouth 25a, the sealing element 23 is sufficiently soft to elastically enclose the threading element 26 of the container mouth 25a. Typically, for this purpose, the sealing element 23 is treated with water vapor before the application of the PT closure 21 onto a container 5, in order to bring about the necessary softness of the sealing element 23. After cooling of the sealing element 23, a counter-threading in the form of a negative of the threading element 26 of the container mouth is formed in the sealing element 23.

An upper end 24 of the container mouth 25a is in contact with the sealing element 23.

In order to open the container 25, the PT closure 21 is removed from the container 25 by a rotation.

FIGS. 9 to 11 show a composite closure 41 (Band-Guard) which is capable of operating analogously to the described PT closure 21.

The composite closure 41 comprises a support with a metallic section 51 and a plastic section 52, a tamper-evident closure 53 and a safety button 50a. The tamper-evident closure 53 is designed so that it is removed from the rest of the composite closure 41 when the composite closure 41 is removed from the container 45, and it is used to allow a consumer to verify whether the composite closure 41 has already been removed from the container 45. The safety button 50a is designed and capable of operating analogously to the safety button 10b of the cam screw closure 1.

The plastic section of the composite closure 41 can comprise a multiple axially extending recesses 56, in order to increase the stability of the closure.

A sealing element 43 is arranged in the composite closure 41 so that it is in contact with both the metallic section 51 and the plastic section 52. In order to close a container 45, the composite closure 41 is pressed onto the container mouth 45a of the container 45, so that at least the upper end 44 of the container mouth 45a is in contact with the sealing element 43.

The plastic section 52 of the support comprises multiple offset projections 54 which interact with the threading elements 46 of the container mouth 45a. In order to open a container 45 which is closed with the composite closure 41, the composite closure 41 can be rotated relative to the container 45.

The distance h₃ of a sealing element 3 between an upper end 4 of a container mouth 5a of a container 5 and the lower side of a support 11 of the closure 1 is represented in FIG. 12 and described here in reference to a cam screw closure 1. Analogously, the distance (height) h₃ for other closure types is to be determined.

The sealing element 3 wedged between the container mouth 5 and the support 11 of the container closure 1 has a height h₃ which exists when a container 5 is closed with the closure 1. If the height h₃ is too small, there is a risk of cutting through the sealing element 3, whereby the tightness of the closed container 5 can be negatively affected. If the height h₃ is too large, the tightness of the closed container is negatively affected, since the contact surface between the upper end 4 of the container mouth 5a and the sealing element 3 is insufficiently large. In order to achieve a suitable impression of the upper end 4 of the container mouth 5a into the sealing element, the composition of the sealing element 3 is crucial.

Below, embodiment examples of the invention are shown and provided with a number, wherein the number designates the respective embodiment example.
1. A sealing element (3, 23, 43, 63) made of a polymer material, wherein the polymer material comprises a polymer composition, wherein . . .
(a) the polymer composition comprises at least one polyolefin,
(b) the polymer material is in the form of a foamed material, and
(c) optionally, the foamed polymer material has a density, determined according to DIN EN ISO 1183-1, of no more than 0.950 g cm⁻³.
2. The sealing element according to example 1, wherein the density of the polymer material is no more than 0.920 g cm⁻³, in particular no more than 0.875 g cm⁻³, preferably 0.860 g cm³, preferably no more than 0.840 g cm⁻³, more preferably no more than 0.820 g cm⁻³, even more preferably no more than 0.800 g cm⁻³, specifically no more than 0.780 g cm⁻³.
3. The sealing element according to any one of the preceding examples, wherein the polymer material is physically or chemically foamed, in particular chemically foamed.
4. The sealing element according to any one of the preceding examples, wherein the density of the foamed polymer material is at least 10% less than the density of the polymer material in an unfoamed state, preferably the density of the foamed polymer material is at least 15%, more preferably at least 20%, more preferably at least 25%, even more preferably at least 30%, most preferably at least 35% less than the density of the polymer material in an unfoamed state.
5. The sealing element according to any one of the preceding examples, wherein the polymer material is in the form of a closed-cell foamed material.
6. The sealing element according to any one of the preceding examples, wherein the polymer composition comprises a butene copolymer (as the at least one polyolefin), wherein the butene copolymer has a melting temperature Tₘ between 30° C. and 130° C., wherein the melting temperature Tₘ is determined by the second heating curve of a DSC measurement at a heating rate of 10° C. min⁻¹.
7. The sealing element according to example 6, wherein the melting temperature Tₘ of the butene copolymer is between 40° C. and 125° C., in particular between 80° C. and 125° C.
8. The sealing element according to example 6 or 7, wherein propene is a comonomer of the butene copolymer.
9. The sealing element according to any one of examples 6 to 8, wherein the butene copolymer is a bipolymer.
10. The sealing element according to any one of examples 6 to 9, wherein the butene polymer is contained at between 0.1% by weight and 80% by weight, preferably between 5% by weight and 60% by weight, particularly preferably between 8% by weight and 55% by weight, in the polymer composition.
11. The sealing element according to any one of examples 6 to 10, wherein the polymer composition comprises an additional butene copolymer, wherein the butene copolymers are different polymer types.
12. The sealing element according to example 11, wherein a comonomer of the additional butene copolymer is ethene.
13. The sealing element according to example 11 or 12, wherein the additional butene copolymer is a butene bipolymer.
14. The sealing element according to any one of examples 11 to 13, wherein the additional butene copolymer is contained at between 10% by weight and 80% by weight, preferably between 22% by weight and 70% by weight, particularly preferably between 40% by weight and 65% by weight, in the polymer composition.
15. The sealing element according to any one of examples 6 to 14, wherein the polymer composition comprises a polyethene.
16. The sealing element according to example 15, wherein the polyethene is a homo-polyethene, in particular LDPE or HDPE.
17. The sealing element according to example 15 or 16, wherein the polyethene is contained at between 5% by weight and 60% by weight, preferably between 10% by weight and 45% by weight, particularly preferably between 15% by weight and 35% by weight, in the polymer composition.
18. The sealing element according to any one of examples 1 to 17, wherein the polymer composition comprises a random propene copolymer.
19. The sealing element according to example 18, wherein ethene is a comonomer of the random propene copolymer.
20. The sealing element according to example 18 or 19, wherein the random propene copolymer is a bipolymer.
21. The sealing element according to any one of examples 18 to 20, wherein the random propene copolymer is contained at between 5% by weight and 60% by weight, preferably between 10% by weight and 45% by weight, particularly preferably between 15% by weight and 35% by weight, in the polymer composition.
22. The sealing element according to any one of examples 6 to 21, wherein the polymer composition comprises a butene homopolymer.
23. The sealing element according to example 22, wherein the butene homopolymer is contained at between 5% by weight and 60% by weight, preferably between 10% by weight and 45% by weight, particularly preferably between 15% by weight and 35% by weight, in the polymer composition.
24. The sealing element according to any one of examples 6 to 23, wherein the polymer composition contains a copolymer which comprises styrene as a comonomer.
25. The sealing element according to example 24, wherein the copolymer which comprises styrene as a comonomer is an SBS, SEPS, SEEPS or SEBS, in particular an SEBS.
26. The sealing element according to example 24 or 25, wherein the copolymer which comprises styrene as a comonomer is contained at between 10% by weight and 70% by weight, preferably between 20% by weight and 60% by weight, particularly preferably between 35% by weight and 55% by weight, in the polymer composition.
27. The sealing element according to any one of examples 24 to 26, wherein the polymer composition comprises a butene homopolymer.
28. The sealing element according to example 27, wherein the butene homopolymer is contained at between 5% by weight and 60% by weight, preferably between 10% by weight and 45% by weight, particularly preferably between 15% by weight and 35% by weight, in the polymer composition.
29. The sealing element according to any one of examples 6 to 9, wherein the butene copolymer is contained at at least 80% by weight, preferably at least 90% by weight, in the polymer composition.
30. The sealing element according to any one of examples 1 to 29, wherein the polymer composition comprises no more than 10% by weight of homo-polypropene, preferably no homo-polypropene.
31. The sealing element according to any one of examples 1 to 30, wherein the polymer composition comprises no more than 10% by weight, preferably no more than 5% by weight, of a component which is liquid at 20° C. and 1000 hPa, particularly preferably the polymer composition comprises no component which is liquid at 20° C. and 1000 hPa.
32. The sealing element according to any one of examples 1 to 31, wherein the polymer composition is a polyolefin composition.
33. The sealing element according to any one of examples 6 to 32, wherein the polymer composition has a static friction coefficient, determined according to DIN EN ISO 8295, of no more than 0.50, preferably no more than 0.40.
34. The sealing element according to any one of examples 1 to 33, wherein the polymer composition comprises up to 15% by weight, preferably up to 8% by weight, particularly preferably up to 6% by weight, of additives.
35. The sealing element according to example 34, wherein the additives are selected from the group consisting of: pigments, nucleation agents, brighteners, stabilizers, surfactants, lubricants, antioxidants and combinations thereof.
36. The sealing element according to any one of examples 6 to 35, wherein the polymer composition has an oxygen permeability rate, determined according to DIN 53380, of less than 3000 cm³ m⁻² d⁻¹ bar⁻¹, preferably less than 2500 cm³ m⁻² d⁻¹ bar⁻¹, more preferably less than 2000 cm³ m⁻² d⁻¹ bar⁻¹, more preferably less than 1500 cm³ m⁻² d⁻¹ bar⁻¹, more preferably less than 1200 cm³ m⁻² d⁻¹ bar⁻¹, more preferably less than 800 cm³ m⁻² d⁻¹ bar⁻¹, more preferably less than 500 cm³ m⁻² d⁻¹ bar⁻¹, preferably less than 400 cm³ m⁻² d⁻¹ bar⁻¹.
37. The sealing element according to any one of examples 6 to 35, wherein the polymer composition has a total migration, determined according to DIN-EN 1186-14, of no more than 1.20 mg cm⁻², preferably no more than 1.0 mg cm²², particularly preferably no more than 0.8 mg cm⁻²
38. The sealing element according to any one of examples 1 to 5, wherein the polymer composition comprises a heterophasic copolymer (as the at least one polyolefin).
39. The sealing element according to example 38, wherein the heterophasic copolymer is a heterophasic propene-ethene copolymer, in particular heterophasic propene-ethene bipolymer.
40. The sealing element according to example 38 or 39, wherein the heterophasic copolymer is contained at between 0.1% by weight and 50% by weight, preferably between 0.1% by weight and 30% by weight, particularly preferably between 0.1% by weight and 20% by weight, specifically between 5% by weight and 20% by weight, in the polymer composition.
41. The sealing element according to any one of examples 38 to 40, wherein the polymer composition comprises a butene copolymer, in particular a butene bipolymer.
42. The sealing element according to example 41, wherein the butene copolymer has a copolymerized proportion of butene of at least 60 mol %, preferably at least 70 mol %, particularly preferably at least 80 mol %.
43. The sealing element according to example 41 or 42, wherein a comonomer of the butene copolymer is ethene.
44. The sealing element according to any one of examples 41 to 43, wherein the butene copolymer is contained at between 10% by weight and 85% by weight, preferably between 30% by weight and 85% by weight, particularly preferably between 50% by weight and 75% by weight, in the polymer composition.
45. The sealing element according to any one of examples 41 to 44, wherein the butene copolymer is a random copolymer.
46. The sealing element according to any one of examples 38 to 45, wherein the polymer composition comprises a polyethene homopolymer, in particular LDPE.
47. The sealing element according to example 46, wherein the polyethene homopolymer is contained at between 0.1% by weight and 60% by weight, preferably between 0.1% by weight and 40% by weight, particularly preferably between 0.1% by weight and 20% by weight, specifically between 5% by weight and 20% by weight, in the polymer composition.
48. The sealing element according to any one of examples 38 to 47, wherein the polymer composition comprises no more than 20% by weight of homo-polypropene, preferably no more than 10% by weight of homo-polypropene, particularly preferably no homo-polypropene.
49. The sealing element according to any one of examples 38 to 48, wherein the polymer composition comprises no more than 10% by weight, preferably no more than 5% by weight, of a component which is liquid at 20° C. and 1000 hPa, particularly preferably the polymer composition comprises no component which is liquid at 20° C. and 1000 hPa.
50. The sealing element according to any one of examples 38 to 49, wherein the polymer composition is a polyolefin composition.
51. The sealing element according to any one of examples 38 to 50, wherein the polymer composition has a static friction coefficient, determined according to DIN EN ISO 8295, of no more than 0.50, preferably no more than 0.40.
52. The sealing element according to any one of examples 38 to 51, wherein the polymer composition comprises up to 15% by weight, preferably up to 8% by weight, particularly preferably up to 4% by weight, of additives.
53. The sealing element according to example 52, wherein the additives are selected from the group consisting of: pigments, nucleation agents, brighteners, stabilizers, surfactants, lubricants, antioxidants and combinations thereof.
54. The sealing element according to any one of examples 38 to 53, wherein the polymer composition has an oxygen permeability rate, determined according to DIN 53380, of less than 3000 cm³ m⁻² d⁻¹ bar⁻¹, preferably less than 2500 cm³ m⁻² d⁻¹ bar⁻¹, more preferably less than 2000 cm³ m⁻² d⁻¹ bar⁻¹, more preferably less than 1500 cm³ m⁻² d⁻¹ bar⁻¹, more preferably less than 1200 cm³ m⁻² d⁻¹ bar⁻¹, more preferably less than 800 cm³ m⁻² d⁻¹ bar⁻¹, more preferably less than 500 cm³ m⁻² d⁻¹ bar⁻¹, preferably less than 400 cm³ m⁻² d⁻¹ bar⁻¹.
55. The sealing element according to any one of examples 38 to 54, wherein the polymer composition has a total migration, determined according to DIN-EN 1186-14, of no more than 1.0 mg cm⁻², preferably no more than 0.8 mg cm⁻².
56. The sealing element according to any one of examples 1 to 5, wherein the polymer composition comprises . . .
(a) between 5% by weight and 50% by weight of a first polymer, wherein the first polymer is a random copolymer which has a Shore D hardness, measured according to DIN ISO 7619-1 at 23° C., of at least 35; and
(b) between 50% by weight and 95% by weight of a second polymer, wherein the second polymer is a polyolefin (is the at least one polyolefin) which has a Shore A hardness, measured according to DIN ISO 7619-1 at 23° C., of no more than 90, in particular no more than 85.
57. The sealing element according to example 56, wherein propene is a comonomer of the first polymer, in particular the comonomer proportion of propene in the first polymer is more than 50 mol %.
58. The sealing element according to example 56 or 57, wherein the first polymer is a random propene-ethene copolymer or a random propene-1-hexene copolymer or a random propene-1-octene copolymer.
59. The sealing element according to example 56, wherein 1-butene is a comonomer of the first polymer, in particular the comonomer proportion of 1-butene in the first polymer is more than 50 mol %.
60. The sealing element according to example 59, wherein the first polymer is a random 1-butene-ethene copolymer.
61. The sealing element according to any one of examples 56 to 60, wherein the first polymer has a density, determined according to DIN EN ISO 1183-1, of at least 0.890 g cm⁻³, in particular more than 0.890 g cm⁻³, and/or the second polymer has a density of less than 0.890 g cm⁻³, in particular less than 0.880 g cm⁻³.
62. The sealing element according to any one of examples 56 to 61, wherein the first polymer has a melting point Tₘ between 80° C. and 160° C., wherein the melting temperature Tₘ is determined by the second heating curve of a DSC measurement at a heating rate of 10° C. min⁻¹.
63. The sealing element according to any one of examples 56 to 62, wherein the first polymer has a Shore D hardness, measured according to DIN ISO 7619-1 at 23° C., between 40 and 80, preferably between 50 and 70, particularly preferably between 57 and 67.
64. The sealing element according to any one of examples 56 to 63, wherein the second polymer is a (random) copolymer.
65. The sealing element according to any one of examples 56 to 64, wherein 1-butene is a comonomer of the second polymer, in particular the second polymer is a (random) 1-butene-ethene copolymer.
66. The sealing element according to example 65, wherein the comonomer proportion of 1-butene in the second polymer is more than 50 mol %, preferably at least 60 mol %, particularly preferably at least 80 mol %.
67. The sealing element according to any one of examples 56 to 66, wherein the second polymer has a Shore A hardness, measured according to DIN ISO 7619-1 at 23° C., between 30 and 85, preferably between 40 and 80, particularly preferably between 50 and 70, even more preferably between 55 and 65.
68. The sealing element according to any one of examples 56 to 67, wherein the first polymer is contained at between 10% by weight and 40% by weight, preferably between 15% by weight and 35% by weight, particularly preferably between 20% by weight and 30% by weight, in the polymer composition.
69. The sealing element according to any one of examples 56 to 68, wherein the second polymer is contained at between 55% by weight and 85% by weight, preferably between 60% by weight and 80% by weight, particularly preferably between 65% by weight and 75% by weight, in the polymer composition.
70. The sealing element according to any one of examples 56 to 69, wherein the polymer composition comprises no more than 10% by weight, preferably no more than 5% by weight, of a component which is liquid at 20° C. and 1000 hPa, particularly preferably the polymer composition comprises no component which is liquid at 20° C. and 1000 hPa.
71. The sealing element according to any one of examples 56 to 70, wherein the polymer composition comprises up to 15% by weight, preferably up to 8% by weight, particularly preferably up to 6% by weight, of additives.
72. The sealing element according to example 71, wherein the additives are selected from the group consisting of: pigments, nucleation agents, brighteners, stabilizers, surfactants, lubricants, antioxidants and combinations thereof.
73. The sealing element according to any one of examples 56 to 72, wherein the polymer composition has an oxygen permeability rate, determined according to DIN 53380, of less than 3000 cm³ m⁻² d⁻¹ bar⁻¹, preferably less than 2500 cm³ m⁻² d⁻¹ bar⁻¹, more preferably less than 2000 cm³ m⁻² d⁻¹ bar⁻¹, more preferably less than 1500 cm³ m⁻² d⁻¹ bar⁻¹, more preferably less than 1200 cm³ m⁻² d⁻¹ bar⁻¹, more preferably less than 800 cm³ m⁻² d⁻¹ bar⁻¹, more preferably less than 600 cm³ m⁻² d⁻¹ bar⁻¹, more preferably less than 500 cm³ m⁻² d⁻¹ bar⁻¹, more preferably less than 400 cm³ m⁻² d⁻¹ bar⁻¹.
74. The sealing element according to any one of examples 56 to 73, wherein the polymer composition has a total migration, determined according to DIN-EN 1186-14, of no more than 1.20 mg cm⁻², preferably no more than 1.0 mg cm⁻², particularly preferably no more than 0.8 mg cm⁻².
75. The sealing element according to any one of examples 56 to 74, wherein the polymer composition has a static friction coefficient, determined according to DIN EN ISO 8295, of no more than 0.50, preferably no more than 0.40, particularly preferably no more than 0.30.
76. The sealing element according to any one of examples 1 to 5, wherein the polymer composition comprises . . .
(a) a polyalphaolefin with a kinematic viscosity, determined according to ASTM D445/ISO 3104, of at least 4 cSt at a temperature of 100° C., and/or with a dropping point, determined according to ASTM 5950, of at most −10° C.; and
(b) up to 95% by weight of a second polyolefin (as the at least one polyolefin).
77. The sealing element according to example 76, wherein the polyalphaolefin has a kinematic viscosity at a temperature of 100° C., determined according to ASTM D445/ISO 3104, between 4 cSt and 1500 cSt, preferably between 50 cSt and 1000 cSt, more preferably between 120 cSt and 1000 cSt, even more preferably between 250 cSt and 1000 cSt.
78. The sealing element according to example 76 or 77, wherein the polyalphaolefin has a dropping point, determined according to ASTM 5950, of at most −20° C., preferably at most −30° C.
79. The sealing element according to any one of examples 76 to 78, wherein the polyalphaolefin has a density, determined according to ASTM D4052, of up to 0.860 g cm⁻³, in particular between 0.825 g cm⁻³ and 0.855 g cm⁻³.
80. The sealing element according to any one of examples 76 to 79, wherein the polyalphaolefin has an average molecular weight Mw, determined according to DIN 55672-1, of at least 440 Da, preferably between 440 Da and 12,000 Da, particularly preferably between 1000 Da and 10,000 Da, even more preferably between 3000 Da and 10,000 Da.
81. The sealing element according to any one of examples 76 to 80, wherein the polyalphaolefin is a metallocene polyalphaolefin, in particular the polyalphaolefin has been produced using a metallocene catalyst.
82. The sealing element according to any one of examples 76 to 81, wherein the polyalphaolefin is a homopolymer or a copolymer, in particular the polyalphaolefin comprises a C₃ to C₂₂ alpha-olefin as (co)monomer.
83. The sealing element according to any one of examples 76 to 82, wherein the polyalphaolefin comprises a C₆ to C₁₄ alpha-olefin, preferably a C₈ to C₁₀ alpha-olefin, as (co)monomer.
84. The sealing element according to any one of examples 76 to 83, wherein the polyalphaolefin is contained at a proportion of up to 65% by weight, preferably between 3% by weight and 65% by weight, more preferably between 3% by weight and 50% by weight, even more preferably between 3% by weight and 30% by weight, most preferably between 5% by weight and 30% by weight, in the polymer composition.
85. The sealing element according to any one of examples 76 to 84, wherein the second polyolefin has a Shore A hardness, determined according to DIN ISO 7619-1 at 23° C., of at most 90, in particular between 30 and 90.
86. The sealing element according to any one of examples 76 to 85, wherein the second polyolefin is a plastomer or an elastomer, in particular the second polyolefin is a polyolefin elastomer with a density, determined according to DIN EN ISO 1183-1, of less than 0.860 g cm⁻³, or the second polyolefin is a polyolefin plastomer with a density, determined according to DIN EN ISO 1183-1, between 0.860 g cm⁻³ and 0.910 g cm⁻³.
87. The sealing element according to any one of examples 76 to 86, wherein the second polyolefin is a (random) copolymer, preferably the copolymer comprises 1-butene and a C₂, C₃ or C₅ to C₁₆ (alpha-)olefin as comonomers, preferably the copolymer comprises 1-butene at a proportion of more than 50 mol % as comonomer.
88. The sealing element according to any one of examples 76 to 87, wherein the second polyolefin is a (random) copolymer, preferably the copolymer comprises propene and a C₂, C₄ or C₅ to C₁₆ (alpha-)olefin as comonomers, preferably the copolymer comprises propene at a proportion of more than 50 mol % as comonomer.
89. The sealing element according to any one of examples 76 to 88, wherein the second polyolefin is a (random or block) copolymer, preferably the copolymer comprises ethene and a C₅ to C₁₆ (alpha) olefin as comonomers, more preferably the copolymer comprises ethene and a C₅, C₇, C₉ or C₁₀ to C₁₆ (alpha-)olefin as comonomers, even more preferably the copolymer comprises ethene at a proportion of more than 50 mol % as comonomer.
90. The sealing element according to any one of examples 76 to 89, wherein the second polyolefin is contained at a proportion of at most 80% by weight, preferably at most 70% by weight or between 5% by weight and 95% by weight, preferably between 20% by weight and 95% by weight, even more preferably between 50% by weight and 95% by weight, in the polymer composition.
91. The sealing element according to any one of examples 76 to 90, wherein the polymer composition comprises a third polymer, in particular a third polyolefin.
92. The sealing element according to example 91, wherein the third polymer has a Shore D hardness, determined according to DIN ISO 7619-1 at 23° C., of at most 60, in particular between 20 and 60.
93. The sealing element according to example 91 or 92, wherein the third polymer is a homopolymer, in particular the homopolymer is constructed from a C₂ to C₁₂ (alpha-)olefin, preferably a C₂ to C₈ (alpha-)olefin, particularly preferably a C₂ to C₆ (alpha-)olefin.
94. The sealing element according to example 93, wherein the homopolymer is a polyethene homopolymer, a polypropene homopolymer, in particular a syndiotactic polypropene homopolymer, or a 1-butene homopolymer.
95. The sealing element according to example 91 or 92, wherein the third polymer is a copolymer, in particular the copolymer comprises at least one or at least two C₂ to C₁₂ (alpha-)olefins as comonomers, preferably at least one or at least two C₂ to C₅ (alpha-)olefins as comonomers, particularly preferably at least one or at least two C₂ to C₆ (alpha-)olefins as comonomers.
96. The sealing element according to example 95, wherein the copolymer is a propene-ethene copolymer, in particular with a proportion of propene of more than 50 mol %, or a propene-hexene copolymer, in particular with a proportion of propene of more than 50 mol %.
97. The sealing element according to any one of examples 91 to 96, wherein the third polymer is contained at a proportion of at most 35% by weight, preferably between 5% by weight and 35% by weight, particularly preferably between 5% by weight and 27% by weight, even more preferably between 5% by weight and 18% by weight, most preferably between 11% by weight and 18% by weight, in the polymer composition.
98. The sealing element according to any one of examples 76 to 97, wherein the polymer composition comprises a fourth polymer, in particular a fourth polyolefin.
99. The sealing element according to example 98, wherein the fourth polymer has a Shore D hardness, determined according to DIN ISO 7619-1 at 23° C., of at most 60, in particular between 20 and 60.
100. The sealing element according to example 98 or 99, wherein the fourth polymer is a homopolymer in particular the homopolymer is constructed from a C₂ to C₁₂ (alpha-)olefin, preferably a C₂ to C₈ (alpha-)olefin, particularly preferably a C₂ to C₆ (alpha-)olefin.
101. The sealing element according to example 100, wherein the homopolymer is a polyethene homopolymer, a polypropene homopolymer, in particular a syndiotactic polypropene homopolymer, or a poly-1-butene homopolymer.
102. The sealing element according to example 98 or 99, wherein the fourth polymer is a copolymer, in particular the copolymer comprises at least one or at least two C₂ to C₁₂ (alpha-)olefins as comonomers, preferably at least one or at least two C₂ to C₅ (alpha-)olefins as comonomers, particularly preferably at least one or at least two C₂ to C₆ (alpha-)olefins as comonomers.
103. The sealing element according to example 102, wherein the copolymer is a propene-ethene copolymer, in particular with a proportion of propene of more than 50 mol %, or a propene-hexene copolymer, in particular with a proportion of propene of more than 50 mol %.
104. The sealing element according to any one of examples 98 to 103, wherein the fourth polymer is contained at a proportion of at most 35% by weight, preferably between 5% by weight and 35% by weight, particularly preferably between 5% by weight and 27% by weight, even more preferably between 5% by weight and 18% by weight, most preferably between 11% by weight and 18% by weight.
105. The sealing element according to any one of examples 76 to 104, wherein the polymer composition comprises up to 15% by weight, preferably up to 8% by weight, particularly preferably up to 6% by weight, most preferably up to 5% by weight, of additives.
106. The sealing element according to example 105, wherein the additives are selected from the group consisting of: pigments, nucleation agents, brighteners, stabilizers, surfactants, lubricants, antioxidants and combinations thereof.
107. The sealing element according to any one of examples 76 to 106, wherein the polymer composition has an oxygen permeability rate, determined according to DIN 53380, of less than 3000 cm³ m⁻² d⁻¹ bar⁻¹, preferably less than 2500 cm³ m⁻² d⁻¹ bar⁻¹, more preferably less than 2000 cm³ m⁻² d⁻¹ bar⁻¹, more preferably less than 1500 cm³ m⁻² d⁻¹ bar⁻¹, more preferably less than 1200 cm³ m⁻² d⁻¹ bar⁻¹, more preferably less than 800 cm³ m⁻² d⁻¹ bar⁻¹, more preferably less than 1300 cm³ m⁻² d⁻¹ bar⁻¹, more preferably less than 900 cm³ m⁻² d⁻¹ bar⁻¹, more preferably less than 750 cm³ m⁻² d⁻¹ bar⁻¹.
108. The sealing element according to any one of examples 76 to 107, wherein the polymer composition has a total migration, determined according to DIN-EN 1186-14, of no more than 5.5 mg cm⁻², preferably no more than 3.5 mg cm⁻², particularly preferably no more than 2.5 mg cm², most preferably no more than 1.5 mg cm⁻².
109. The sealing element according to any one of the preceding examples, wherein the sealing element is free of PVC.
110a. The sealing element according to any one of the preceding examples, wherein the polymer composition is a polyolefin composition.
110b. The sealing element according to any one of the preceding examples, wherein the polymer composition comprises a syndiotactic polypropene homopolymer or a syndiotactic polypropene copolymer.
110c. The sealing element according to example 110b, wherein the syndiotactic polypropene homopolymer or the syndiotactic polypropene copolymer is contained at at most 35% by weight in the polymer composition, in particular is contained at between 5% by weight and 35% by weight, preferably between 5% by weight and 27% by weight, more preferably between 5% by weight and 18% by weight, even more preferably between 11% by weight and 18% by weight, in the polymer composition.
111. A sealing element (3, 23, 43, 63) made of a polymer material, wherein the polymer material comprises a polymer composition, wherein . . .
(a) the polymer composition contains polyvinyl chloride,
(b) the polymer material is in the form of a foamed material, and,
(c) optionally, the foamed polymer material has a density, determined according to DIN EN ISO 1183-1, of no more than 1.100 g cm⁻³.
112. The sealing element according to example 111, wherein the PVC is soft PVC, in particular with a density (in unfoamed state), determined according to DIN EN ISO 1183-1, between 1.200 g cm⁻³ and 1.350 g cm⁻³.
113. The sealing element according to example 111 or 112, wherein the density of the foamed polymer material, determined according to DIN EN ISO 1183-1, is no more 1.000 g cm⁻³, preferably no more than 0.900 g cm⁻³, more preferably no more than 0.850 g cm⁻³, most preferably no more than 0.780 g cm⁻³.
114. The sealing element according to any one of examples 111 to 113, wherein the polymer composition contains between 20% by weight and 70% by weight, preferably between 30% by weight and 50% by weight, of plasticizer.
115. The sealing element according to any one of the preceding examples, wherein the sealing element consists of the polymer material.
116. A container closure (1, 21, 41, 61) with a sealing element according to any one of the preceding examples.
117. The container closure according to example 116, wherein the container closure comprises a support (11, 31, 51, 71) and the sealing element (3, 23, 43, 63), wherein the support (11, 31, 51, 71) comprises metal and/or plastic, in particular comprises metal or plastic as main component.
118. The container closure according to example 116 or 117, wherein the container closure (1, 21, 41, 61) is a screw closure, in particular a cam screw closure (1), a press-on twist-off closure (21) or a composite closure (41, 61).
119. A container (5, 25, 45) with a container mouth (5a, 25a, 45a) and a closable opening at the end of the container mouth, wherein the opening is closed with a container closure (1, 21, 41, 61) according to any one of examples 116 to 118.
120. The container according to example 119, wherein the container is a glass container, a plastic container or a metal container.
121. The container according to example 119 or 120, wherein the container closure comprises a support (11, 31, 51, 71) and the sealing element (3, 23, 43, 63), and wherein the sealing element, between an upper end (4, 24, 44) of the container mouth and a lower side of the support (11, 31, 51, 71), has a height (h₃) of no more 1.0 mm, preferably no more than 0.8 mm, particularly preferably no more than 0.7 mm, in axial direction of the container.
122. The container according to any one of examples 119 to 121, wherein the container closure comprises a support (11, 31, 51, 71) and the sealing element (3, 23, 43, 63), and wherein the sealing element, between an upper end (4, 24, 44) of the container mouth and a lower side of the support (11, 31, 51, 71), has a height (h₃) of at least 0.2 mm, preferably at least 0.4 mm, particularly preferably at least 0.5 mm, in axial direction of the container.
123. The container according to any one of examples 119 to 122, wherein the absolute pressure in the closed container is no more than 200 hPa, preferably no more than 100 hPa.
124. The container according to any one of examples 119 to 123, wherein the container has a safety margin of no more than 10 mm, preferably no more than 8 mm, particularly preferably no more than 6 mm, most preferably no more than 4 mm.
125. A method for producing a closed and filled container, having the steps of:
(a) providing a container (1, 21, 41, 61) with a container mouth (5a, 25a, 45a) and a closable opening at the end of the container mouth;
(b) filling the container with a food through the opening of the container;
(c) closing the opening of the container with a container closure according to any one of examples 116 to 118.
126. The method according to example 125, wherein the opening of the container has a diameter of at least 20 mm.
127. The method according to example 125 or 126, wherein the container is a glass container, a plastic container or a metal container.
128. The method according to any one of examples 125 to 127, wherein the container closure is treated at a temperature of at least 90° C. before the opening of the container is closed with the container closure.
129. The method according to any one of examples 125 to 128, wherein the opening of the container has a diameter of at most 120 mm.
130. The method according to any one of examples 125 to 129, wherein the container, after the filling with a food, has a head space which comprises no food, and vapor, in particular water vapor, is supplied to the head space before the opening of the container is closed with the container closure.
131. The method according to any one of examples 125 to 130, wherein the absolute pressure in the closed and filled container is no more than 200 hPa, preferably no more than 100 hPa.
132. The method according to any one of examples 125 to 131, wherein, during the closing of the opening of the container with the container closure and/or during a thermal treatment of the closed and filled container, the sealing element of the container closure is deformed at least 0.2 mm, preferably at least 0.4 mm, particularly preferably at least 0.5 mm, in axial direction of the container to form an impression of the container mouth in the sealing element.
133. The method according to any one of examples 125 to 132, wherein, during the closing of the opening of the container with the container closure and/or during a thermal treatment of the closed and filled container, the sealing element of the container closure is deformed no more than 1.0 mm, preferably no more than 0.8 mm, particularly preferably no more than 0.7 mm, in axial direction of the container to form an impression of the container mouth in the sealing element.
134. The method according to any one of examples 125 to 133, wherein the closed and filled container is thermally treated at a temperature which is above the temperature of the food during the filling of the container.
135. The method according to any one of examples 125 to 134, wherein the closed and filled container is thermally treated at a temperature of at least 60° C.
136. The method according to any one of examples 125 to 134, wherein the closed and filled container is thermally treated at a temperature between 60° C. and 135° C., preferably at an absolute pressure surrounding the container of no more than 4.0 bar.
137. The method according to any one of examples 125 to 136, wherein the pressure in the closed and filled container during the thermal treatment is less than the pressure outside of the closed container.
138. The method according to any one of examples 125 to 137, wherein the food is poured at a temperature of no more than 10° C. into the container.
139. The method according to any one of examples 125 to 138, wherein the food is aseptically poured into the container.
140. The method according to any one of examples 125 to 137, wherein the food is poured at a temperature between 70° C. and 98° C. into the container.
141. The method according to any one of examples 125 to 137, wherein the food is poured at a temperature between 10° C. and 70° C. into the container.
142. A method for producing a foamed sealing element, in particular a foamed sealing element according to any one of examples 1 to 115, the method having the steps of . . .
(a) introducing a propellant into a/the polymer composition;
(b) foaming the polymer composition by the propellant, whereby a foamed polymer material is produced;
(c) forming the sealing element from the foamed polymer material.
143. The method according to example 142, wherein the polymer composition is a polymer composition of examples 1 to 115, in particular a polymer composition of examples 2 to 115, specifically without their respective back reference to example 1.
144. The method according to example 142 or 143, wherein the propellant is introduced into an extruder and mixed with the polymer composition in the extruder.
145. The method according to any one of examples 142 to 144, wherein the sealing element is formed by stamping or by application onto a surface, in particular it is formed by application onto a surface and subsequent stamping.
146. The method according to any one of examples 142 to 145, wherein, due to the foaming, the density of the foamed polymer material is at least 10%, preferably at least 15%, more preferably at least 20%, more preferably at least 25%, even more preferably at least 30%, most preferably at least 35%, lower than the density of the polymer composition.
147. The method according to any one of examples 142 to 146, wherein up to 10.0% by weight of the propellant, with respect to the total weight of the polymer composition including the propellant, are introduced into the polymer composition, in particular between 0.1% by weight and 8.0% by weight, preferably between 0.1% by weight and 6.0% by weight, more preferably between 0.2% by weight and 5.0% by weight, are introduced into the polymer composition.
148. The method according to any one of examples 142 to 147, wherein the propellant contains at least two different solids.
149. The method according to any one of examples 142 to 148, wherein the propellant contains at least one first substance and contains at least one second substance, wherein, due to a chemical reaction of the first substance and the second substance, carbon dioxide forms.
150. The method according to example 149, wherein the first substance is a carbonate or a carbamate, in particular an alkali, alkaline earth, aluminum, transition metal or ammonium compound thereof or a mixture thereof, particularly preferably a sodium, magnesium, calcium, aluminum or iron compound thereof or a mixture thereof.
151. The method according to either example 149 or 150, wherein the second substance comprises a salt which contains phosphorus, comprises in particular a salt of a phosphate.
152. The method according to any one of examples 149 to 151, wherein the second substance contains two different compounds, wherein both compounds chemically react with the first substance so that carbon dioxide forms by both reactions.
153. The method according to example 152, wherein, by the reaction of the first compound of the second substance with the first substance, within a unit of time, a first quantity of carbon dioxide forms, and by the reaction of a second compound of the second substance with the first substance, within the unit of time, a second quantity of carbon dioxide forms, wherein the quantities of carbon dioxide formed within the same unit of time are of different size.
154. The method according to example 153, wherein the quantities of carbon dioxide formed differ by at least a factor of 1.2, preferably by at least a factor of 1.5.
155. The method according to any one of examples 149 to 154, wherein the chemical reaction is triggered at a temperature of at least 70° C., preferably the chemical reaction is triggered at a temperature of at least 100° C., particularly preferably the chemical reaction is triggered at a temperature between 120° C. and 200° C.
156. The method according to any one of examples 149 to 155, wherein the propellant contains a separating agent, by means of which a chemical reaction between the first substance and the second substance is inhibited or delayed.
157. A method for producing a container closure, wherein a foamed sealing element according to any one of examples 142 to 156 is produced, wherein the sealing element is formed in a container closure blank or formed outside of the container closure blank and introduced into the container closure blank.

### EXAMPLES

Examples of polymer compositions for a sealing element are represented in Tables 1 to 5. The examples are designated with Ex. and a consecutive number for the respective example.

The designations of the components represented in the tables stand for . . .
C4C3 1-Butene-propene copolymer with a 1-butene proportion of more than 50 mol %,
C4C2 A 1-Butene-ethene copolymer with a 1-butene proportion of more than 50 mol %,
LDPE Ethene homopolymer (low-density polyethylene),
HDPE Ethene homopolymer (high-density polyethylene),
C3C2 Propene-ethene copolymer with a propene proportion of more than 50 mol %,
C4 1-Butene homopolymer,
HECO Heterophasic copolymer (propene-ethene copolymer),
C3C6 Propene-1-hexene copolymer with a propene proportion of more than 50 mol %,
C4C2 B 1-Butene-ethene copolymer with a 1-butene proportion of more than 50 mol %,
PAO-5 Polyalphaolefin (poly-1-olefin) with a kinematic viscosity at 100° C. of approximately 5 cSt,
PAO-65 Polyalphaolefin with a kinematic viscosity at 100° C. of approximately 65 cSt,
PAO-150 Polyalphaolefin with a kinematic viscosity at 100° C. of approximately 150 cSt,
PAO-300 Polyalphaolefin with a kinematic viscosity at 100° C. of approximately 300 cSt.

The C4C3 (1-butene-propene copolymer) has a melting temperature of 114° C., determined according to ISO 11357-3. The Shore A hardness of C4C3 is 87, determined according to DIN ISO 7619-1 at 23° C. and with a holding time of 15 s. The density, determined according to DIN EN ISO 1183-1, of the C4C3 is 0.870 g cm⁻³.

The C4C2 A (1-butene-ethene copolymer with more than 50 mol % of butene) has a Shore A hardness (DIN ISO 7619-1, 23° C., 15 s) of 60, an MFI (190° C., 2.16 kg) of 1.3 g/10 min and a density of 0.870 g cm⁻³. The 1-butene-ethene copolymer A has no melting point, thus the random 1-butene-ethene copolymer A has no melting temperature Tₘ which can be determined by the second heating curve of a DSC measurement at a heating rate of 10° C. min⁻¹.

The LDPE (ethene homopolymer) has a Shore D hardness (DIN ISO 7619-1, 23° C., holding time 15 s) of 48. The density (DIN EN ISO 1183-1) of the LDPE is 0.928 g cm⁻³.

The HDPE (ethene homopolymer) has a Shore D hardness (DIN ISO 7619-1, 23° C., holding time 15 s) of 55. The density (DIN EN ISO 1183-1) of the HDPE is 0.954 g cm⁻³.

The C3C2 (propene-ethene copolymer with more than 50 mol % of propene) has a Shore D hardness (DIN ISO 7619-1, 23° C., holding time 15 s) of 58, an MFI (190° C., 2.16 kg) 7 g/10 min and a density of 0.900 g cm⁻³.

The C4 (1-butene homopolymer) has a Shore D hardness (DIN ISO 7619-1, 23° C., holding time 15 s) of 54 and the density (DIN EN ISO 1183-1) of the C4 is 0.915 g cm⁻³.

The HECO (propene-ethene copolymer) comprises a continuous phase and a dispersed phase, wherein the continuous phase is formed by homo-polypropene and the phase dispersed therein is formed by a propene-ethene copolymer. The density (DIN EN ISO 1183-1) of the HECO is 0.900 g cm⁻³.

The C3C6 (propene-1-hexene copolymer) has a Shore D hardness (DIN ISO 7619-1, 23° C., holding time 15 s) of 62 and a density of 0.900 g cm⁻³.

The C4C2 B (butene-ethene copolymer with more than 50 mol % of butene) has a Shore D hardness (DIN ISO 7619-1, 23° C., holding time 15 s) of 62 and a density of 0.910 g cm⁻³. The melting temperature Tₘ of the C4C2 B is 103° C.

The polyalphaolefins (PAO-5, PAO-65, PAO-150, PAO-300) are commercially available from Chevron Phillips or from ExxonMobil (for example, SpectraSyn series).

TABLE 1

| | Ex. 1 | Ex. 2 | Ex. 3 | Ex. 4 | Ex. 5 | Ex. 6 | Ex. 7 |
|---|---|---|---|---|---|---|---|
| Component, | | | | | | | |
| % by weight | | | | | | | |
| C4C3 | 94.9 | 47.5 | 12.0 | 12.0 | 12.0 | 12.0 | 12.0 |
| C4C2 A | | 47.4 | 59.9 | 59.9 | 59.9 | 59.9 | 59.9 |
| LDPE | | | 23.0 | | | | 7.0 |
| HDPE | | | | 23.0 | | | |
| C3C2 | | | | | 23.0 | | 16.0 |
| C4 | | | | | | 23.0 | |
| Additives, | 5.1 | 5.1 | 5.1 | 5.1 | 5.1 | 5.1 | 5.1 |
| % by weight | | | | | | | |
| Properties | | | | | | | |
| Friction | 0.32 | 0.26 | 0.23 | 0.17 | 0.19 | 0.20 | 0.17 |
| coefficient, | | | | | | | |
| dimensionless | | | | | | | |
| Total migration, | 0.56 | 0.79 | 0.88 | 0.83 | 1.05 | 0.81 | 0.96 |
| mg cm⁻² | | | | | | | |
| Oxygen | 370 | 364 | 409 | 307 | 413 | 325 | 368 |
| permeability | | | | | | | |
| rate, | | | | | | | |
| cm³ m⁻² d⁻¹ bar⁻¹ | | | | | | | |

TABLE 2

| | Ex. 8 | Ex. 9 | Ex. 10 |
|---|---|---|---|
| Component, % by weight | | | |
| HECO | 24.0 | 12.0 | 17.5 |
| C4C2 A | 72.0 | 72.0 | 70.5 |
| LDPE | — | 12.0 | 6.0 |
| Additives, % by weight | 4.0 | 4.0 | 6.0 |
| Properties | | | |
| Friction coefficient, dimensionless | 0.37 | 0.36 | 0.34 |
| Total migration, mg cm⁻² | 0.6 | 0.7 | 0.8 |
| Oxygen permeability rate, cm³ m⁻² d⁻¹ bar⁻¹ | 326 | 391 | 369 |

TABLE 3

| | Ex. 11 | Ex. 12 | Ex. 13 |
|---|---|---|---|
| Component, % by weight | | | |
| C4C2 A | 71.9 | 71.9 | 71.9 |
| C3C2 | 24.0 | | |
| C3C6 | | 24.0 | |
| C4C2 B | | | 24.0 |
| Additives, % by weight | 4.1 | 4.1 | 4.1 |
| Properties | | | |
| Friction coefficient, dimensionless | 0.30 | 0.24 | 0.26 |
| Total migration, mg cm⁻² | 1.0 | 0.9 | 0.9 |
| Oxygen permeability rate, cm³ m⁻² d⁻¹ bar⁻¹ | 479 | 478 | 356 |

TABLE 4

| | Ex. 14 | Ex. 15 | Ex. 16 | Ex. 17 | Ex. 18 | Ex. 19 | Ex. 20 |
|---|---|---|---|---|---|---|---|
| Component, | | | | | | | |
| % by weight | | | | | | | |
| PAO-5 | 4.8 | 9.1 | 16.7 | | | | 9.1 |
| PAO-65 | | | | 9.1 | | | |
| PAO-150 | | | | | 9.1 | | |
| PAO-300 | | | | | | 9.1 | |
| C4C2 A | 68.5 | 65.4 | 59.9 | 65.4 | 65.4 | 65.4 | |
| C4C3 | | | | | | | 87.2 |
| LDPE | 15.2 | 14.5 | 13.3 | 14.5 | 14.5 | 14.5 | |
| C3C2 | 7.6 | 7.3 | 6.7 | 7.3 | 7.3 | 7.3 | |
| C3C6 | | | | | | | |
| C4 | | | | | | | |
| Additives | 3.9 | 3.7 | 3.4 | 3.7 | 3.7 | 3.7 | 3.7 |
| Property | | | | | | | |
| Friction | 0.31 | 0.33 | 0.39 | 0.36 | 0.23 | 0.18 | 0.28 |
| coefficient, | | | | | | | |
| dimensionless | | | | | | | |
| Total migration, | 2.14 | 3.27 | 5.11 | 1.35 | 1.15 | 0.99 | 2.90 |
| mg cm⁻² | | | | | | | |
| Oxygen | 662 | 809 | 1162 | 732 | 681 | 650 | 680 |
| permeability | | | | | | | |
| rate, | | | | | | | |
| cm³ m⁻² d⁻¹ bar⁻¹ | | | | | | | |

TABLE 5

| | Ex. 21 | Ex. 22 | Ex. 23 | Ex. 24 | Ex. 25 | Ex. 26 | Ex. 27 | Ex. 28 | Ex. 29 |
|---|---|---|---|---|---|---|---|---|---|
| Component, | | | | | | | | | |
| % by weight | | | | | | | | | |
| PAO-300 | 20.0 | 30.0 | 40.0 | 5.0 | 10.0 | 20.0 | 10.0 | 10.0 | 10.0 |
| C4C2 A | | | | 90.9 | 85.9 | 75.9 | 61.9 | 61.9 | 61.9 |
| C4C3 | 75.9 | 65.9 | 55.9 | | | | | | |
| LDPE | | | | | | | 24.0 | | |
| C3C6 | | | | | | | | 24.0 | |
| C4 | | | | | | | | | 24.0 |
| Additives | 4.1 | 4.1 | 4.1 | 4.1 | 4.1 | 4.1 | 4.1 | 4.1 | 4.1 |
| % by weight | | | | | | | | | |

1% by weight of a propellant granulate can be added to the polymer compositions of examples Ex. 1 to Ex. 29. The propellant granulate as master batch contains the propellant in a polymer matrix (LDPE). The proportion of (active) propellant in the propellant granulate is 50% (% by weight). Thus, after the addition, the respective polymer composition contains 1% by weight of propellant granulate, whereof propellant is contained at 0.5% by weight. Thereby, the portion in percent of all the components in the respective polymer composition is correspondingly reduced.

As propellant, in an example, a stoichiometric mixture (for maximum carbon dioxide release) of sodium hydrogen carbonate (first substance), acidic sodium pyrophosphate and sodium aluminum phosphate (compounds of the second substance) is used.

A polymer composition with a propellant granulate proportion of 1% by weight (propellant 0.5% by weight) and with a density before foaming of 0.900 g cm⁻³ was foamed by means of the propellant. After the reaction of the first substance with the second substance, the foamed polymer material had a density of 0.720 g cm⁻³.

In general, no specific component is necessarily present in the polymer composition. Specifically, an increased occurrence of a component in the examples cannot be an indication that this component necessarily has to be contained in the polymer composition. Instead, components can be omitted from the compositions of the examples or replaced by another component (other components). Likewise, components can be added.

1. A sealing element made of a polymer material, wherein the polymer material comprises a polymer composition, wherein . . .
(a) the polymer composition comprises at least one polyolefin,
(b) the polymer material is in the form of a foamed material, and
(c) the foamed polymer material has a density, determined according to DIN EN ISO 1183-1, of no more than 0.950 g cm⁻³.

2-5. (canceled)

6. The sealing element according to claim 1, wherein the polymer composition comprises a butene copolymer, wherein the butene copolymer has a melting temperature Tₘ between 30° C. and 130° C., wherein the melting temperature Tₘ is determined by the second heating curve of a DSC measurement at a heating rate of 10° C. min⁻¹.

7. The sealing element according to claim 6, wherein propene is a comonomer of the butene copolymer.

8. (canceled)

9. The sealing element according to claim 6, wherein the polymer composition comprises an additional butene copolymer, wherein the butene copolymers are different polymer types.

10. The sealing element according to claim 9, wherein a comonomer of the additional butene copolymer is ethene.

11. (canceled)

12. The sealing element according to claim 6, wherein the polymer composition comprises a polyethene.

13. (canceled)

14. The sealing element according to claim 6, wherein the polymer composition comprises a random propene-ethene copolymer.

15. (canceled)

16. The sealing element according to claim 6, wherein the polymer composition comprises a butene homopolymer, wherein the butene homopolymer is contained at between 5% by weight and 60% by weight.

17. (canceled)

18. The sealing element according to claim 1, wherein the polymer composition comprises a heterophasic copolymer.

19-22. (canceled)

23. The sealing element according to claim 18, wherein the polymer composition comprises a polyethene homopolymer.

24. (canceled)

25. The sealing element according to claim 1, wherein the polymer composition comprises . . .
(a) between 5% by weight and 50% by weight of a first polymer, wherein the first polymer is a random copolymer which has a Shore D hardness, measured according to DIN ISO 7619-1 at 23° C., of at least 35; and
(b) between 50% by weight and 95% by weight of a second polymer, wherein the second polymer is a polyolefin, which has a Shore A hardness, measured according to DIN ISO 7619-1 at 23° C., of no more than 90.

26. The sealing element according to claim 25, wherein the first polymer is a random propene-ethene copolymer or a random propene-1-hexene copolymer or a random propene-1-octene copolymer.

27. The sealing element according to claim 25, wherein the first polymer is a random 1-butene-ethene copolymer.

28-32. (canceled)

33. The sealing element according to claim 1, wherein the polymer composition comprises . . .
(a) a polyalphaolefin with a kinematic viscosity, determined according to ASTM D445/ISO 3104, of at least 4 cSt, at a temperature of 100° C., and/or with a dropping point, determined according to ASTM 5950, of at most −10° C.; and
(b) up to 95% by weight of a second polyolefin.

34-50. (canceled)

51. A container closure (1, 21, 41, 61) with a sealing element according to claim 1.

52. (canceled)

53. A method for producing a foamed sealing element according to claim 1, the method having the steps of . . .
(a) introducing a propellant into the polymer composition;
(b) foaming the polymer composition by the propellant, whereby a foamed polymer material is produced;
(c) foaming the sealing element out of the foamed polymer material.

54. (canceled)

55. The method according to claim 53, wherein the propellant is introduced into an extruder and mixed with the polymer composition in the extruder.

56. The method according to claim 53, wherein the sealing element is formed by stamping or by application onto a surface.

57. (canceled)

58. The method according to claim 53, wherein up to 10.0% by weight of the propellant, with respect to the total weight of the polymer composition including the propellant, are introduced into the polymer composition, in particular between 0.1% by weight and 8.0% by weight, preferably between 0.1% by weight and 6.0% by weight, more preferably between 0.2% by weight and 5.0% by weight, are introduced into the polymer composition.

59. The method according to claim 53, wherein the propellant contains at least two different solids.

60-67. (canceled)
